(19) United States
(12) Patent Application Publication
(10) Pub. No.: US 2019/0249523 A1
(43) Pub. Date: Aug. 15, 2019

(54) Enhancing Productivity of Subterranean Formations

(71) Applicant: The Board of Regents of the University of Oklahoma, Norman, OK (US)

(72) Inventors: Rouzbeh Ghanbarnezhad Moghanloo, Norman, OK (US); Davud Davudov, Norman, OK (US); Yuzheng Lan, Austin, TX (US)

(21) Appl. No.: 16/246,169

(22) Filed: Jan. 11, 2019

Related U.S. Application Data
(60) Provisional application No. 62/630,618, filed on Feb. 14, 2018.

(51) Int. Cl. E21B 41/00; G01N 15/08; E21B 49/00; E21B 43/26; E21B 43/119; E21B 43/25

(52) U.S. Cl. CPC E21B 41/0092; G01N 15/0886; E21B 43/25; E21B 43/26; E21B 43/119; E21B 49/005

(57) ABSTRACT

The disclosure is directed to a method, and system for analyzing a subterranean formation for designing an oil field service to be completed in a borehole of the subterranean formation for enhancing recovery of oil or gas from the formation. The subterranean formation may be an unconventional reservoir.

### CROSS-REFERENCE TO RELATED APPLICATIONS

The present patent application claims priority to United States Provisional Patent Application U.S. Ser. No. 62/630,618, filed on Feb. 14, 2018, the entire contents of which is hereby expressly incorporated herein by reference.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

The significant growth of hydrocarbon production in North America is due to increased development activities (massive fracturing) in such as unconventional tight formations such as the Eagle Ford and Bakken shale plays. However, the ultimate primary recovery from unconventional tight resources is very low (<10%). Therefore, a significant amount of oil remains unexploited with the current practice and there is a need for advanced techniques to determine where to lay out fracture clusters along a horizontal well. The complexity of shale plays can, in part, be attributed to the geological and petrophysical heterogeneity of the reservoir rocks themselves. Shales are comprised of common minerals such as silica dioxide, but also include considerable amounts of clays and organic matter; wherein, the latter is an essential constituent of productive shale plays. Shales with 50% of grains smaller than 62.5 μm in diameter fall into a category of mudrocks. These small grains combined with the clay minerals generate multifarious pore geometry. Pores are observed at various locations inside the shale matrix. For example, the porosity in the Barnett, Kimmeridge, and Horn River shales is dominantly within the organic matter, while the porosity in the Haynesville shale is most prevalent in the inorganic part.

Detailed studies of scanning electron microscope (SEM) images reveal the very small sized pores, and hence very low connectivity in shale matrix. Based on 3D shale microstructure, Curtis et al (2011) noted that only 19% of total porosity is connected. Ewing and Horton (2002) conducted Monte Carlo simulations using random walks to mimic steady state diffusion in porous media with sparsely connected pore spaces, and observed a decrease in diffusivity with increasing sample size associated with both a decrease in effective porosity and an increase in tortuosity. Hu et al (2012) examined pore connectivity with three experimental approaches (imbibition, tracer concentration profiles, and imaging), which yielded very low connectivity in a shale matrix. Davudov et al. (2016) also studied connectivity in shale formations based on MICP data, reporting that the percentage of accessible pores in Barnett and Haynesville shale fields is around 30%. Civan (2003) used the leaky tube model to elucidate the difference between accessible and inaccessible pore types. An accessible pore is considered any part of the interconnected pores, which constitutes the Hydraulic Flow Tube (HFT). The inaccessible pores are of three different types: naturally isolated pores, induced isolated pores, and dead-end pores. Naturally isolated pores are those surrounded by grains and bonding material. Induced isolated pores were originally connected but have become sealed by capillary forces. Dead end pores have one connecting pore throat to the HFT, but no transient flow. Several studies have addressed the issue of pore compressibility from both theoretical and experimental considerations: (Biot 1941; Dobrynin 1962; Geertsma 1966; Zimmerman et. Al 1986; Andersen 1988; Laurent et al. 1993; Shafer and Neasham 2000; Zimmerman 2000; Bailey 2009; Comisky et. al 2011). However, each of these studies suffers from certain deficiencies. Accurate assessment of the pore structure characteristic and pore volume compressibility of shale plays are essential for optimal exploitation of these resources. It is to this goal that the present disclosure is directed.

### BRIEF DESCRIPTION OF THE DRAWINGS

The accompanying drawings, which are incorporated in and constitute a part of this specification, illustrate one or more implementations described herein and, together with the description, explain these implementations. The drawings are not intended to be drawn to scale, and certain features and certain views of the figures may be shown exaggerated, to scale or in schematic in the interest of clarity and conciseness. Not every component may be labeled in every drawing. Like reference numerals in the figures may represent and refer to the same or similar element or function.

FIG. 1 shows three schematic images of the Mercury Injection Capillary Pressure (MICP) process at three different stages: conformance, compression and intrusion. The left-hand image shows mercury conforming to the surface of the sample with no significant compression or intrusion happening to the pores. The center image shows the sample at the stage of compression where both accessible pores and inaccessible part of the rock (IRP) are compressed while no intrusion has happened yet. The right-hand image shows the sample during the intrusion stage with IRP being compressed while accessible pores get intruded and filled by mercury. Pore pressure in accessible pores equalizes with confining pressure generated by mercury.

FIG. 2 shows an MICP curve divided into 3 stages. Total pore compressibility is calculated as a function of pressure. The downward trending line is bulk compressibility over confining pressure. The lower line, which curves upwardly, is a cumulative volume of Hg. In this non-limiting example, sample mercury intrusion begins at about 6000 psi. Generally, P_{conf} is around atmospheric pressure and the critical intrusion pressure (P_{ci}) at which intrusion begins is in range of 4000-10,000 psi. Final pressure (P_{f}) at which all accessible pores are filled is in most cases about 60,000 psi. (Data is courtesy of IC3 lab at University of Oklahoma).

FIG. 3 is a flowchart of the implementation of one embodiment of the disclosed methodology.

FIG. 4 is a flowchart showing a macro used to solve the system of equations 7, 13, and 15.

FIG. 5 shows pore compressibility results from two Barnett field samples (A) sample 1, and (B) sample 2.

FIG. 6 shows pore compressibility results from two Haynesville field samples (A) sample 1, and (B) sample 2.

FIG. 7 shows pore compressibility results from two Bakken field samples (A) sample 1, and (B) sample 2.

FIG. 8 shows pore compressibility results from two Eagle Ford field samples (A) sample 1, and (B) sample 2.

FIG. 9 shows the contribution of corrections on calculated porosity for Barnett samples.

FIG. 10 shows a capillary pressure curve for a selected sample before and after correction.

FIG. 11 shows the contribution of corrections on mercury saturation curve for a Barnett sample.

FIG. 12 shows the contribution of corrections on pore size distribution for a Barnett sample.

FIG. 13 shows the contribution of corrections on permeability calculations curve for Barnett and Haynesville samples.

FIG. 14 shows the impact of pore compressibility on permeability reduction for Haynesville samples (A) sample 1, and (B) sample 2.

FIG. 15 shows an example of depletion efficiency before and after correction.

FIG. 16 shows an example of a rock expansion index before and after correction.

FIG. 17 shows examples of contributions of several aspects and embodiments of the present disclosure.

FIG. 18 shows an illustration of how cuttings are obtained and collected during a drilling operation then evaluated by an MCIP test during “real time.”

### DETAILED DESCRIPTION

Methods and systems for enhancing well performance in subterranean formations, particularly unconventional reservoirs, are sought throughout the oil and gas industry. Since decompression of rock and fluid is the main production mechanism in the primary production from tight hydrocarbon reservoirs such as shale and tight sands, an accurate understanding of pore volume compressibility of rock is vital for reservoir engineers when estimating storage capacity and reservoir deliverability, and thus the feasibility of projects in such formations. However, as shown herein, without corrected measures of pore volume compressibility, the accuracy of well deliverability becomes problematic. Correcting for pore volume compressibility allows for improved accuracy in geomechanic aspects, hydrocarbon reserve evaluation, and prediction of production performance. Also, geomechanical models of subsidence and compaction can also be influenced by the relative (bulk) compressibility magnitude. Compaction and subsidence yield permeability decreases, fracture closure, and pore shrinkage, making an understanding of the dual pore compressibility system imperative to evaluation.

The present disclosure describes a novel approach to evaluating subterranean formations such as, but not limited to, unconventional tight gas and oil strata, for enhancing production performance, particularly by improving well completion. As a well is being drilled, the rock that is undergoing the drilling is cut or otherwise fragmented into small pieces, called “cuttings.” In one embodiment described herein, samples of these cuttings are removed from the wellbore (borehole) in the formation via drilling fluid. These cuttings comprise samples of the rock at various distances through which the well is being drilled. Residue of the drilling fluid can be removed from the obtained cuttings and then the cuttings can undergo further analysis. Data based on Mercury Injection Capillary Pressure (MICP) are obtained from the cuttings and/or core samples and are used in a model described below to determine accessible pore and inaccessible part of the rock (IRP) compressibility as a function of pressure. During MICP testing in a typical shale sample, the rock sample experiences conformance, compression, and intrusion as effective pressure increases. Compressibility values based on MICP data are characterized as a function of pressure. The calculated compressibility values for accessible pores generally appear to be much greater (two to three orders of magnitude) than those of IRP.

Next, how calculated accessible pore compressibility values affect gas recovery in several shale gas plays was evaluated. Results demonstrated that using accessible pore compressibility values instead of total pore compressibility values significantly changes the reservoir behavior prediction. Currently, the fundamental rock property utilized in many reservoir engineering calculations including reserves estimates, reservoir performance and production forecasting is total pore compressibility, which has an approximate value typically within the 1×10⁻⁶ psi⁻¹ to 1×10⁻⁵ psi⁻¹ range. By replacing values of total pore compressibility with values of accessible pore compressibility, calculated values of total pore volume compressibility change by nearly two orders of magnitude. Novel aspects of the present disclosure include, but are not limited to: a mathematical model for calculating pore compressibility for rock (e.g., shale) formations based on MICP data, ability to separately estimate accessible pore and IRP compressibility values, ability to correct accessible porosity measured with MICP test for the pore compressibility effect, ability to evaluate the positive effect of pore compressibility on production, the ability to evaluate the negative effect of pore compressibility on shale apparent permeability, and the ability to design or revise a completion plan and determine an oil field service, such as for making real time changes in a drilling operation, e.g., during borehole drilling or during well completion.

Well completion includes implementing a staging design, which in one embodiment is a plan of the locations of the multiple hydraulic fracturing stages and/or perforation clusters which will be performed on a borehole (horizontal or vertical) of a well. A single stage, which is individually designed, planned, and executed, comprises one part in a series of work to be done to complete the well before production can begin. Stages are usually defined by a sequential list of numbers and may include a description of the well depth interval(s) and or services to be performed. Stages can also relate to the people, equipment, technical designs, or time periods for each interval (typically related to pressure pumping). Selective staging, wherein only certain portions of the wellbore (borehole) undergo fracturing and/or perforation, is highly desirable in the industry because implementation of each stage is costly and time consuming. Limiting the number of stages that must be implemented is thus desirable. The embodiments of the present disclosure enable selective staging due to the information derived from the samples obtained during drilling.

The results obtained by the methods described herein can be input into a software-based reservoir simulation model which uses pore compressibility as input to predict reservoir quality or other reservoir characteristics, which is (are) used to determine a completion design for locating the fracturing and/or perforation stages in the borehole from which the rock samples (e.g., cuttings) were removed, and/or to determine an oil field service to be performed at a well site, such as hydraulic fracturing and/or perforation. Examples of such software-based reservoir simulation models include, but are not limited to, those shown in U.S. Pat. Nos. 6,842,725, 7,177,764; and 7,496,488, and U.S. Patent Application Publications 2010/0076738, 2010/0088076, 2010/0185393, 2010/0250215, and 2009/0248374, the entire contents of each of which is explicitly incorporated herein by reference.

In certain embodiments, determination of the completion design and/or the performance of the oil field service occurs within one or more hours of the analysis of the rock samples (e.g., cuttings), such as within one hour, two hours, four hours, 6 hours, 12 hours, 18 hours, or 24 hours, or later (e.g., within one week, one month, 12 months, or 24 months, or later). The analysis may occur before production occurs (e.g., while drilling) or may occur during reservoir characterization during production.

Before describing various embodiments of the present disclosure in more detail by way of exemplary description, examples, and results, it is to be understood as noted above that the present disclosure is not limited in application to the details of methods and apparatus as set forth in the following description. The present disclosure is capable of other embodiments or of being practiced or carried out in various ways. As such, the language used herein is intended to be given the broadest possible scope and meaning; and the embodiments are meant to be exemplary, not exhaustive. Also, it is to be understood that the phraseology and terminology employed herein is for the purpose of description and should not be regarded as limiting unless otherwise indicated as so. Moreover, in the following detailed description, numerous specific details are set forth in order to provide a more thorough understanding of the disclosure. However, it will be apparent to a person having ordinary skill in the art that the embodiments of the present disclosure may be practiced without these specific details. In other instances, features which are well known to persons of ordinary skill in the art have not been described in detail to avoid unnecessary complication of the description.

Unless otherwise defined herein, scientific and technical terms used in connection with the present disclosure shall have the meanings that are commonly understood by those having ordinary skill in the art. Further, unless otherwise required by context, singular terms shall include pluralities and plural terms shall include the singular.

All patents, published patent applications, and non-patent publications mentioned in the specification are indicative of the level of skill of those skilled in the art to which the present disclosure pertains. All patents, published patent applications, and non-patent publications (e.g., articles) referenced in any portion of this application are herein expressly incorporated by reference in their entirety to the same extent as if each individual patent or publication was specifically and individually indicated to be incorporated by reference.

As utilized in accordance with the methods and apparatus of the present disclosure, the following terms, unless otherwise indicated, shall be understood to have the following meanings:

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or when the alternatives are mutually exclusive, although the disclosure supports a definition that refers to only alternatives and “and/or.” The use of the term “at least one” will be understood to include one as well as any quantity more than one, including but not limited to, 2, 3, 4, 5, 6, 7, 8, 9, 10, 15, 20, 30, 40, 50, 100, or any integer inclusive therein. The term “at least one” may extend up to 100 or 1000 or more, depending on the term to which it is attached; in addition, the quantities of 100/1000 are not to be considered limiting, as higher limits may also produce satisfactory results. In addition, the use of the term “at least one of X, Y and Z” will be understood to include X alone, Y alone, and Z alone, as well as any combination of X, Y and Z.

As used herein, all numerical values or ranges include fractions of the values and integers within such ranges and fractions of the integers within such ranges unless the context clearly indicates otherwise. Thus, to illustrate, reference to a numerical range, such as 1-10 includes 1, 2, 3, 4, 5, 6, 7, 8, 9, 10, as well as 1.1, 1.2, 1.3, 1.4, 1.5, etc., and so forth. Reference to a range of 1-50 therefore includes 1, 2, 3, 4, 5, 6, 7, 8, 9, 10, 11, 12, 13, 14, 15, 16, 17, 18, 19, 20, etc., up to and including 50, as well as 1.1, 1.2, 1.3, 1.4, 1.5, etc., 2.1, 2.2, 2.3, 2.4, 2.5, etc., and so forth. Reference to a series of ranges includes ranges which combine the values of the boundaries of different ranges within the series. Thus, to illustrate reference to a series of ranges, for example, of 1-10, 10-20, 20-30, 30-40, 40-50, 50-60, 60-75, 75-100, 100-150, 150-200, 200-250, 250-300, 300-400, 400-500, 500-750, 750-1,000, includes ranges of 1-20, 10-50, 50-100, 100-500, and 500-1,000, for example.

As used herein, the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. The skilled artisan will understand that typically there is no limit on the number of items or terms in any combination, unless otherwise apparent from the context.

Throughout this application, the terms “about” or “approximately” are used to indicate that a value includes the inherent variation of error. Further, in this detailed description, each numerical value (e.g., temperature or time) should be read once as modified by the term “about” or “approximately” (unless already expressly so modified), and then read again as not so modified unless otherwise indicated in context. As noted, any range or consecutive set of numbers listed or described herein is intended to include, implicitly or explicitly, any number within the range or set of numbers, including fractions and whole numbers, including the end points, and is to be considered as having been so stated. For example, “a range from 1 to 10” is to be read as indicating each possible number, particularly integers and fractions, along the continuum between about 1 and about 10. Thus, even if specific data points within the range, or even no data points within the range, are explicitly identified or specifically referred to, it is to be understood that any data points within the range are to be considered to have been specified, and that the inventors possessed knowledge of the entire range and the points within the range. The use of the term “about” or “approximately” may mean a range including ±10% of the subsequent number unless otherwise stated.

As used herein, the term “substantially” means that the subsequently described parameter, function, event, or circumstance completely occurs or that the subsequently described parameter, function, event, or circumstance occurs to a great extent or degree. For example, the term “substantially” means that the subsequently described parameter, function, event, or circumstance occurs at least 75% of the time, at least 80% of the time, at least 85% of the time, at least 90% of the time, at least 91% of the time, or at least 92% of the time, or at least 93% of the time, or at least 94% of the time, or at least 95% of the time, or at least 96% of the time, or at least 97% of the time, or at least 98% of the time, or at least 99% of the time, or means that the dimension or measurement is within at least 75%, or at least 80%, or at least 85%, or at least 90%, or at least 91%, or at least 92%, or at least 93%, or at least 94%, or at least 95%, or at least 96%, or at least 97%, or at least 98%, or at least 99%, of the referenced dimension, function, parameter, or measurement (e.g., length).

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Features of any of the embodiments disclosed herein may be combined with features of any of the other embodiments disclosed herein to create a new embodiment.

Where used herein the term “oil field service” is intended to refer to an operation at a natural gas production site and/or a petroleum (oil) production site. The term “petrophysical” is intended to refer to a parameter related to the physical and/or chemical properties of a rock or rock formation, particularly in regard to the interaction of the rock or rock formation with a fluid. Where used herein the term “unconventional,” when applied to a subterranean formation, refers to a underground reservoir of an oil or natural gas (unconventional oil or natural gas) which requires a stimulation treatment in addition to a drilling operation. Such stimulation treatments include, but are not limited to, fracturing, perforation, acidizing, and staging.

Where used herein, the following abbreviations and initialisms apply:
a: Accessible pore fraction (ϕₐ/ϕ)
b: Langmuir adsorption coefficient, psia⁻¹
B_{g}: Gas formation volume factor, rcf/scf
B_{gi}: Initial gas formation volume factor, rcf/scf
C_{ac}: Compressibility of accessible pore under hydrostatic condition with respect to confining pressure, psia⁻¹
Cₐₚ: Compressibility of accessible pore with respect to pore pressure, psia⁻¹
C_{accuni}: Compressibility of accessible pore measured under uniaxial condition with respect to confining pressure, psia⁻¹
C_{IRPC}: Compressibility of inaccessible part of the rock (IRP) with respect to confining pressure, psia⁻¹
C_{bc}: Bulk compressibility with respect to confining pressure, psia⁻¹
Cₚₐ: Total pore compressibility with respect to confining pressure, psia⁻¹
C_{w}: Compressibility of water, psia⁻¹
Gₚ: Gas production, scf
G_{fgi}: Original gas in drainage area in free gas phase, scf
IRP: Inaccessible part of the rock (grain+inaccessible pore)
k₁: Coefficient for power law function between total pore compressibility and pressure
k₂: Coefficient for power law function between accessible pore compressibility and pressure
k₃: Coefficient for power law function between IRP compressibility and pressure
L_{Hmax}: Pore throat diameter at which hydraulic conductance is maximum, μm
L_{c}: Characteristic length which corresponds to the pore diameter at threshold pressure, μm
m: Power in the power law function between compressibility and pressure
MICP: mercury injection capillary pressure
n: denoted term to represent the value of

$$\frac{{k}_{2}}{m + 1} ( {P}_{c}^{m + 1} - {P}_{{c}_{i}}^{m + 1} )$$

Pᵢ: Initial pressure, psi
P_{c}: Confining pressure, psi
P_{c}_{ᵢ}: Initial confining pressure, psi
P_{ci}: Critical intrusion pressure, psi
P_{conf}: Conformance pressure, psi
p_{f}: Final pressure, psi
psi: pounds per square inch
S(L_{Hmax}): Fraction of connected pore volume including pores with diameter of L_{Hmax} and larger
(S_{b}/p_{c})_{A}: Apex of the bulk volume Hg saturation to capillary pressure ratio, percent/psi
S_{wi}: Initial water saturation
Vₐ: Volume of accessible pores, ml
V_{b}: Bulk volume, ml
V_{bsc}: Bulk volume at standard condition, ml
V_{cf}: Volume of mercury reading at P_{conf}
V_{Hg}(P_{f}): Volume of mercury reading at P_{f}
V_{Hg}(P_{ci}): Volume of mercury reading at P_{ci}
V_{IRP}: Volume of inaccessible part of the rock, ml
Vₚ: Total pore volume, ml
Vₚᵢ: Initial total pore volume, ml
V_{psc}: Total pore volume at standard condition, ml
υ: Poisson's ratio, decimal
υₘₐₓ: Maximum monolayer volumetric capacity per unit weight of solid
ρᵣ: density of the rock, g/ml
ϕₐ: total porosity of the rock, measured from LPP testing
ϕₐ: Accessible porosity calculated from MICP test data
β: Theoretical shape coefficient, valued at 2 or 5/3 depending on assumption
η: Constant to express the impact of accessible porosity in terms of reservoir quality μm: micrometer(s).

Turning now to the description of non-limiting examples of the various embodiments of the present disclosure, a method to calculate accessible pore and inaccessible pore compressibility values based on MICP data is provided. Mercury has a very low compressibility, is non-wetting, and unlike brine/gas, does not damage bonds chemically. With an MICP apparatus selected, the utilization of a method developed by Bailey (2009) to calculate the total pore compressibility was potentially viable. A power law regression was used as outlined in the methodology. The usage of power law function to describe shale compression behavior was carried out. Hydrostatic compression test data from several geomechanical studies on different sandstone and shale showed a convincing power law function trend between bulk volume compressibility and confining pressure (Andersen and Jones 1985, Niandou et. al 1997). Having a protocol for accessible part of the rock and IRP compressibility then allows systematic evaluation of the potential impact effect of discretization. Having a better understanding of these computations leads to better reservoir estimation, with the potential for improved production prediction, and less failed wells due to economic feasibility inaccuracies.

The present work further investigated the accessible and IRP compressibility for several North American shale gas plays using MICP data and describes (1) development of a mathematical model used for calculating compressibility values for both accessible and IRP separately, (2) evaluation of calculated pore compressibility values for Barnett, Haynesville, Bakken, and Eagle Ford shale plays, and (3) application and evaluation of the impact of accessible pore compressibility on reservoir properties.

Methods and Model Description

The accessible pore and IRP compressibility problem was treated as a dynamic problem, in which the values of compressibility for each part of the rock change as a function of effective stress.

One of the major contributions of this model is that it separates out the accessible pore compressibility and provides some supportive insights into the effectiveness of the compaction production mechanism. The bulk system is divided into two parts: accessible pores, which contribute to production directly; and IRP, which is made up of inaccessible porosity and grain and has no direct contribution to production.

A Visual Basic for Applications (VBA) code was developed to compute the compressibility function for both accessible pores and IRP using core data from four shale plays in the United States. Three critical pressure points during the MICP process are considered in the building of this model as explained below.

Methodology

Data from MICP experiments were collected in the IC3 lab at the University of Oklahoma. Blank corrections were run before any data collection to eliminate the effect of mercury compressibility and temperature during the process. Before MICP, core samples were prepared through multiple stages including polishing, drying and vacuuming, which rids the fluids from the pore space of the rock, hence enables the assumption that pore pressure is zero and that confining pressure is the equivalent of effective pressure on the pores before any intrusion happens.

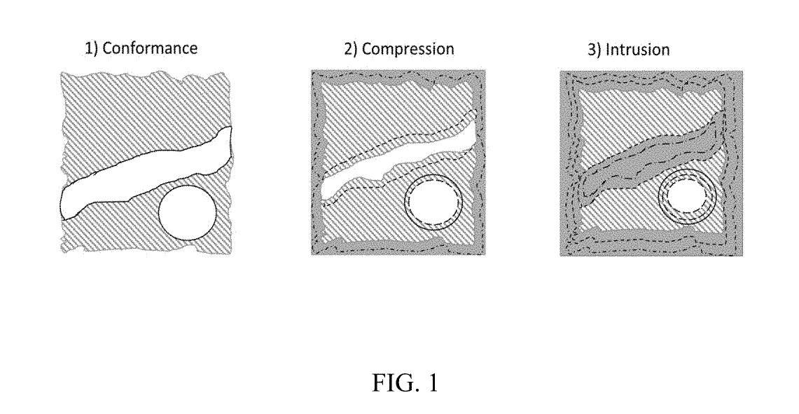

The disclosed model delineates MICP data into three stages: conformance; compression; intrusion. FIG. 1 illustrates a schematic of these three different stages during MICP experiment. The conformance is simply an amount of mercury needed to envelope the external shape of sample before intrusion happens so when pressure reaches to conformance pressure (P_{conf}), the volume of mercury recorded is due to core sample conformance, and has no relation to the pore space in that core.

Between conformance pressure and critical intrusion pressure (P_{ci}), the pressure is not sufficient for mercury to intrude into pores, since the characteristic pore throat size is usually smaller than 20 nm, which can be translated into a critical intrusion pressure using Washburn equation (Washburn 1921). However, both accessible pores and IRP are compressed due to external pressure. Mercury volume recorded at this stage is the sum of the volume change due to compression in both parts of the rock.

Mercury intrusion to accessible pores starts to happen after pressure reaches P_{ci}, since intrusion is the point at which the capillary pressure overtakes the interfacial tension and intermolecular forces; it exceeds the critical pressure (Bailey 2009, Comisky et al. 2011). At this point, mercury begins filling the rock pore volume. When pressure reaches final pressure (P_{f}), all accessible pores are intruded. Mercury volume measured at this pressure is the sum total accessible pore volume, and the volume change due to the compression in IRP.

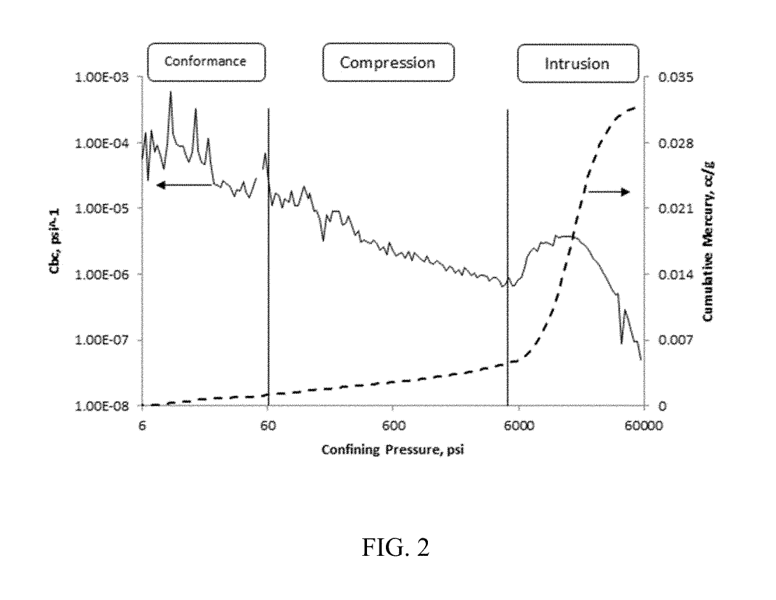

The incremental mercury injection can be used to observe a volume change of the pores in the compression/shrinkage stage. With the incremental pore compressibility established for the defined pressures, they are plotted on a log-log graph such as shown in FIG. 2 (which is based on a sample from Barnett field). The result exhibits a linear appearing trend for the shrinkage period. Any deviation from linear line on log-log scale is due to conformance on low pressure portion and while any deviation at high pressure region is because of intrusion. The resulting slope of the linear trend is defined as the variable in a power law function for calculating pore compressibility at any point.

Mathematical Derivation

The disclosed model describes the behaviors of accessible pore and IRP compressibility with respect to effective stress. An analytical solution was developed to calculate compressibility values for both accessible pores and IRP, separately. The assumptions in the making of this model included: (1) pore system consists of accessible and inaccessible pores, (2) pore pressure is zero before intrusion happens, (3) there is no mercury intrusion into pores before the critical intrusion pressure.

The detailed derivation of this model, with the determination of accessible pore volume at a desired pressure, is shown below. The present model is built with emphasis on conditions at P_{conf}, P_{ci} and P_{f}.

Considering the total bulk volume as a summation of accessible pores and IRP. Therefore, total bulk volume can be written as:

V_{b}=Vₐ+V_{IRP} Eq. 1

where V_{b} represents bulk volume, Vₐ is the volume of accessible pores, and V_{IRP} is the volume of IRP. Taking the derivative with respect to confining pressure on both sides of Eq. 1 yields:

$$\frac{{dV}_{b}}{{dP}_{c}} = \frac{dVa}{{dP}_{c}} + \frac{{dV}_{IRP}}{{dP}_{c}} \qquad Eq . 2$$

where P_{c} represents confining pressure. Eq. 2 shows that the change in bulk volume is simply a linear summation of the change in accessible pore volume and the volume of IRP. This linearity is later found in the relations between bulk compressibility with respect to confining pressure, accessible pore compressibility, and compressibility of the IRP. Eq. 2 can be rewritten as:

$$\begin{matrix}\frac{1}{{V}_{b}} \frac{{dV}_{b}}{{dP}_{c}} = \frac{{V}_{a}}{{V}_{p}} \frac{{V}_{p}}{{V}_{b}} \frac{1}{{V}_{a}} \frac{{dV}_{a}}{{dP}_{c}} + \frac{{V}_{IRP}}{{V}_{p}} \frac{{V}_{p}}{{V}_{b}} \frac{1}{{V}_{IRP}} \frac{{dV}_{IRP}}{{dP}_{c}} & Eq . 3 \\ Hence , {C}_{bc} = \frac{{V}_{a}}{{V}_{p}} φ {C}_{ac} + \frac{{V}_{IRP}}{{V}_{p}} φ {C}_{IRPC} & Eq . 4\end{matrix}$$

where C_{bc}, C_{ac}, and C_{IRPS} represent compressibility of the bulk, accessible pores, and inaccessible part of the rock, respectively, all with respect to confining pressure, and ϕ is porosity of the rock measured from LPP testing, which is considered as absolute porosity of the rock at standard condition. Setting accessible pore volume fraction:

$$\frac{{V}_{a}}{{V}_{p}}$$

as variame a,

$$\frac{{V}_{IRP}}{{V}_{p}}$$

should then be equal to

$$\frac{( 1 - a φ )}{φ} .$$

Eq. 4 then becomes:

C_{bc}=aϕC_{ac}+(1−aϕ)C_{IRPC} Eq. 5

This equation shows a linear relationship between bulk compressibility, accessible pore compressibility, and IRP compressibility. The bulk compressibility of shale can be represented with a power law function. Due to the linearity of the relationship, the equation can be rewritten as a function of pressure:

k₁P^{m}=ak₂P^{m}+(1−aϕ)k₃P^{m} Eq. 6

where k₁, k₂, and k₃ are the coefficients in the power law function with respect to confining pressure for bulk, accessible pores, and IRP respectively. The value m is the power of the function, which remains the same for all three compressibility values due to the linearity of the relationship.

Simplifying Eq. 6 yields:

k₁=ak₂+(1−aϕ)k₃ Eq. 7

Pressure region between P_{conf} and P_{ci} is considered as the compression region, where all of the accessible pores and IRP are compressed. After P_{ci}, a portion of the accessible pores starts to get intruded by mercury, depending on pore throat sizes, which controls the capillary pressure or entry pressure for the pores connected to them. Pressure will equalize for pores that have been intruded, causing them to rebound to original volume. However, pore pressure still remains 0 for pores that have not been intruded. Thus, IRP and the not-yet-intruded accessible pores are still compressed due to effective pressure. MICP reading at the P_{c}, consists of the mercury conforming to the surface and the volume change in both accessible pores and IRP due the compression under P_{ci}. Reviewing the compressibility definition:

$${C}_{ac} = - \frac{1}{{V}_{a}} \frac{{dV}_{a}}{{dP}_{c}} \qquad Eq . 8$$

Rewriting compressibility as a function of pressure gives:

$${k}_{22} {P}^{m} = - \frac{1}{{V}_{a}} \frac{{dV}_{a}}{{dP}_{c}} \qquad Eq . 9$$

which is solved to yield:

$$\frac{{k}_{2}}{m + 1} ( {P}_{2}^{m + 1} - {P}_{1}^{m + 1} ) = ln {V}_{1} - ln {V}_{2} \qquad Eq . 10$$

Therefore, volume of accessible pores at P_{ci} can be written as:

$${V}_{a} ( {P}_{ci} ) = \frac{a φ {V}_{bsc}}{{e}^{[ \frac{{k}_{2}}{m + 1} ( {P}_{ci}^{m + 1} - {P}_{conf}^{m + 1} ) ]}} \qquad Eq . 11$$

where V_{bsc} represents bulk volume under standard conditions, which is determined from MICP readings at standard condition. Similarly, the volume of IRP at P_{ci} can be written as:

$${V}_{IRP} ( {P}_{ci} ) = \frac{( 1 - a φ ) {V}_{bsc}}{{e}^{[ \frac{{k}_{3}}{m + 1} ( {P}_{ci}^{m + 1} - {P}_{conf}^{m + 1} ) ]}} \qquad Eq . 12$$

Hence, mercury reading at Pₛᵢ can be written as:

$${V}_{Hg} ( {P}_{ci} ) = {V}_{bsc} - \frac{a φ {V}_{bsc}}{{e}^{[ \frac{{k}_{2}}{m + 1} ( {P}_{ci}^{m + 1} - {P}_{conf}^{m + 1} ) ]}} - \frac{( 1 - a φ ) {V}_{bsc}}{{e}^{[ \frac{{k}_{3}}{m + 1} ( {P}_{ci}^{m + 1} - {P}_{conf}^{m + 1} ) ]}} + {V}_{cf} \qquad Eq . 13$$

where V_{cf} is the volume of mercury reading at P_{conf}.

When final pressure P_{f} is reached in MICP testing, all the accessible pores are intruded by mercury, wherein IRP will still remain under compression due to effective pressure. The volume of IRP at final pressure can be written as:

$${V}_{IRP} ( {P}_{f} ) = \frac{( 1 - a φ ) {V}_{bsc}}{{e}^{[ \frac{{k}_{3}}{m + 1} ( {P}_{f}^{m + 1} - {P}_{conf}^{m + 1} ) ]}} \qquad Eq . 14$$

Therefore, the mercury reading at P_{f} can be written as:

$${V}_{Hg} ( {P}_{f} ) = {V}_{bsc} - \frac{( 1 - a φ ) {V}_{bsc}}{{e}^{[ \frac{{k}_{3}}{m + 1} ( {P}_{f}^{m + 1} - {P}_{conf}^{m + 1} ) ]}} + {V}_{cf} \qquad Eq . 15$$

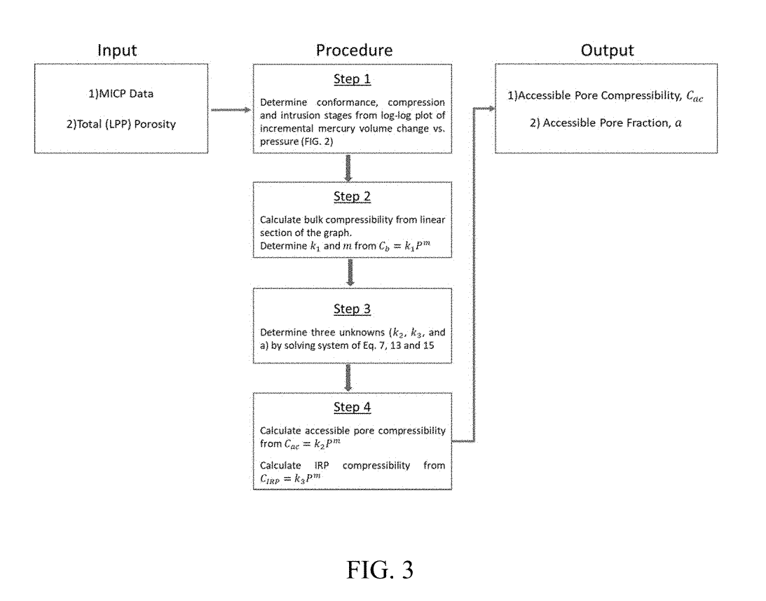

As summarized in FIG. 3, similar to Bailey's model, the linear trend from the log-log plot of incremental mercury volume change vs. pressure (FIG. 2) is used to identify the compression stage and calculate bulk compressibility. Thus k_{b} and m can be determined. Next, total porosity at standard conditions, ϕ is determined using Low Pressure Porosimeter (LPP) testing.

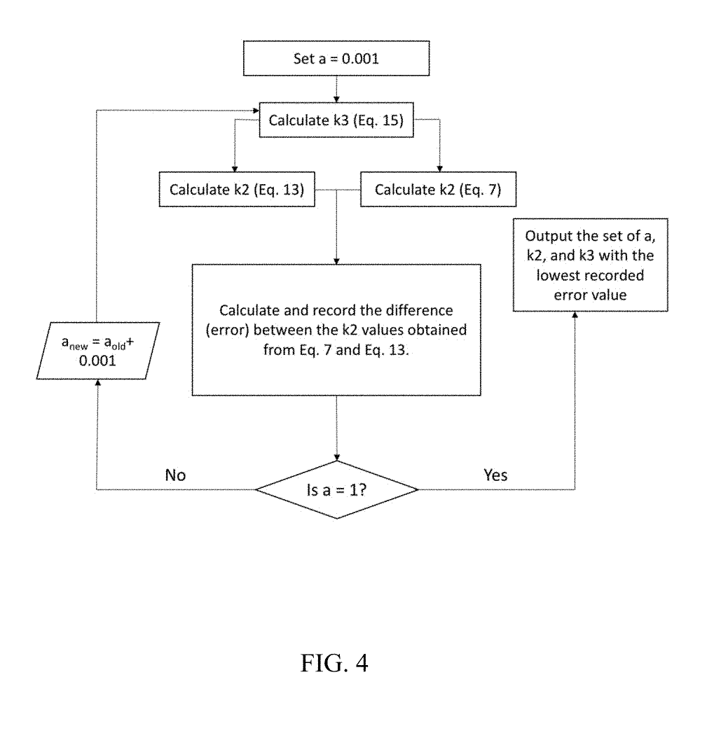

However, to estimate the other three unknowns (accessible pore fraction a; power law coefficient for accessible pore compressibility, k₂, and power law coefficient for accessible pore compressibility k₃) three equations are needed. Combining Eq. 7, 13 and 15, a system of three equations can be solved for these three variables, a, k₂ and k₃, using a macro for solving a numerical bracketed trial and error method such as shown in FIG. 4.

In addition, since compression which occurred during MICP experiments is under hydrostatic condition, a correction must be made to convert hydrostatic compressibility value to uniaxial compressibility to mimic reservoir condition, using Eq. 16 from Zimmerman (2000):

$$\frac{{C}_{accuni}}{{C}_{ap}} = \frac{( 1 + v )}{3 ( 1 - v )} \qquad Eq . 16$$

where C_{accuni} is compressibility of accessible pore with respect to pore pressure in uniaxial condition, Cₐₚ represents the same variable but measured in hydrostatic condition, and v is the Poisson's ratio, taken to be 0.23 as a typical value for shale. Note that this equation is applied herein under an additional assumption that the IRP is incompressible, hence a pseudo Biot's coefficient is assumed to be 1.

Results

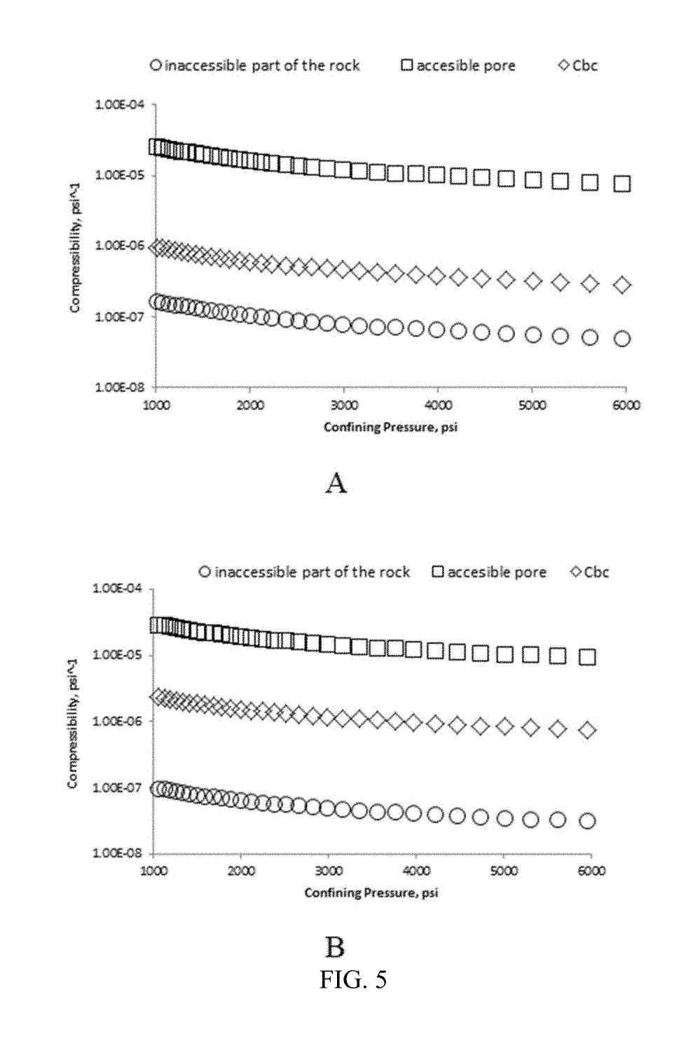

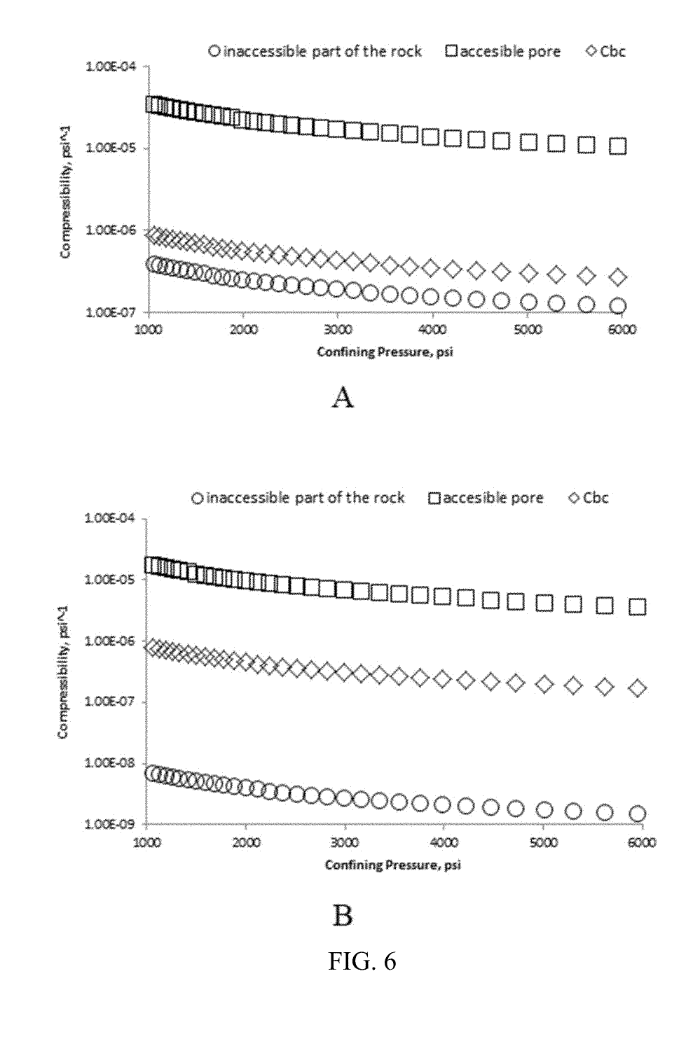

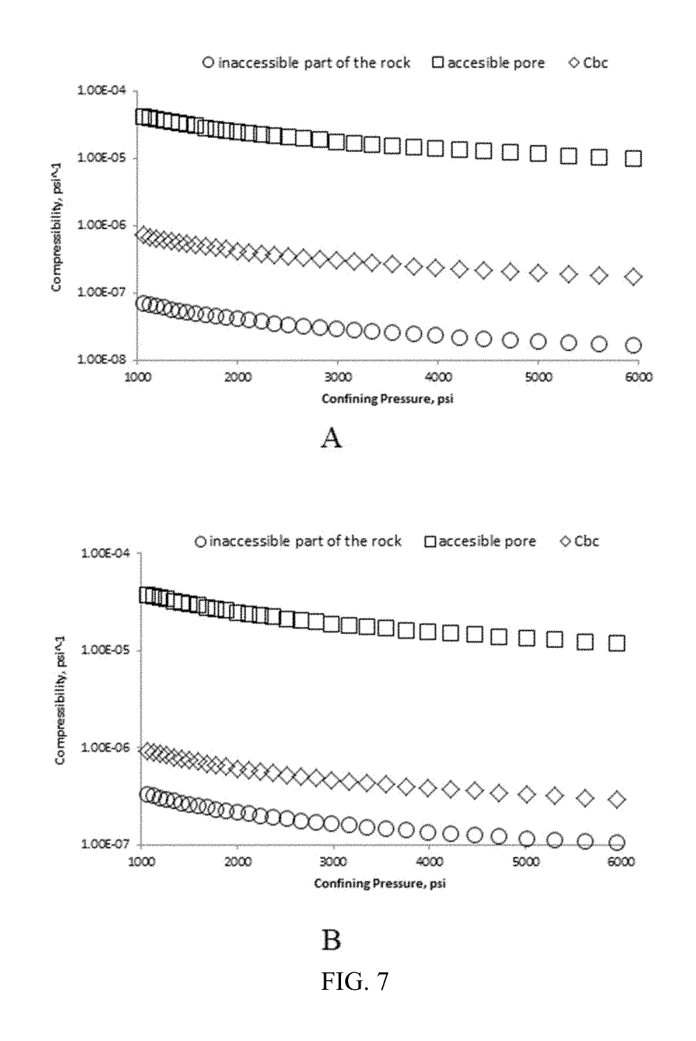

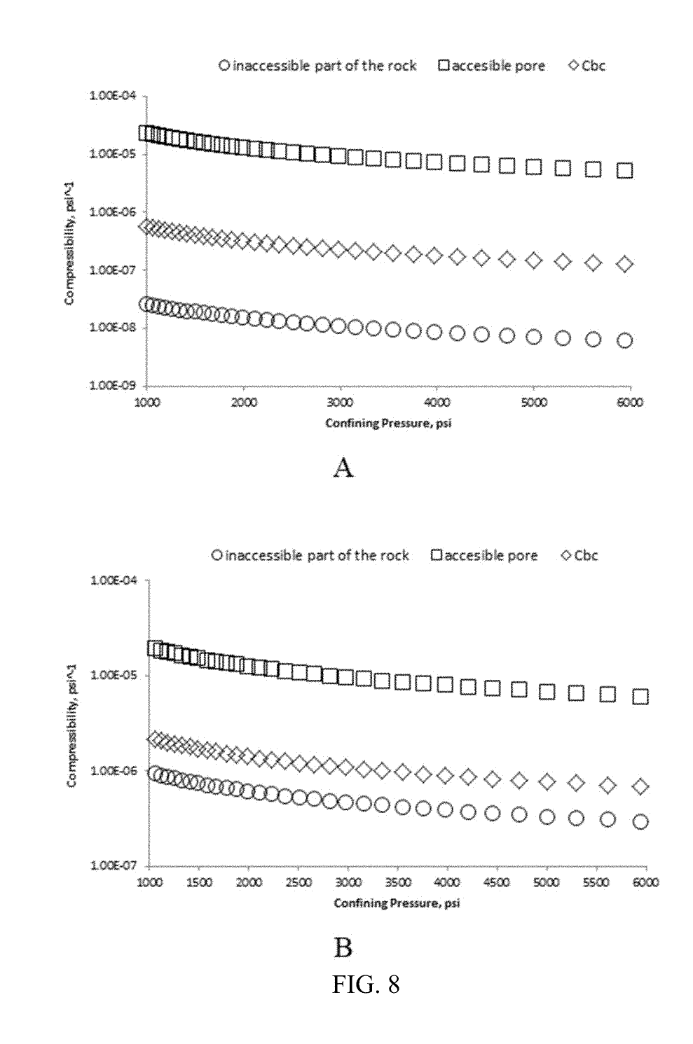

Using the disclosed methodology, accessible pore compressibility, IRP compressibility, and bulk compressibility were obtained as a function of pressure for Barnett, Bakken, Eagle Ford, and Haynesville shale fields (although the methods of the present disclosure are not limited to these formations). It has been observed that for all samples accessible pore and IRP compressibility values are different, where in all cases the former has higher value than the latter. On the other hand, each field has its own signature behavior in accessible pore compressibility and IRP compressibility and volume distribution of each type of pore. Exemplary results are shown in FIGS. 5-8 and are summarized in Table 1. The results exemplify the robustness of the disclosed model and its ability to predict compressibility behavior based on MICP data and some of the other practical applications described below.

TABLE 1
Compressibility results summary for four shale plays

| | Barnett | | Haynesville | | Bakken | | Eagle Ford | |
|---|---|---|---|---|---|---|---|---|
| | Sample 1 | Sample 2 | Sample 1 | Sample 2 | Sample 1 | Sample 2 | Sample 1 | Sample 2 |
| Accessible pore | 0.561 | 0.886 | 0.265 | 0.570 | 0.287 | 0.610 | 0.741 | 0.592 |
| fraction | | | | | | | | |
| Accessible pore | 2.61 × 10⁻⁵~ | 2.92 × 10⁻⁵~ | 3.15 × 10⁻⁵~ | 1.73 × 10⁻⁵~ | 4.00 × 10⁻⁵~ | 3.40 × 10⁻⁵~ | 2.26 × 10⁻⁵~ | 2.02 × 10⁻⁵~ |
| compressibility range, | 7.72 × 10⁻⁶ | 8.95 × 10⁻⁶ | 9.22 × 10⁻⁶ | 3.46 × 10⁻⁶ | 9.10 × 10⁻⁶ | 1.03 × 10⁻⁵ | 5.14 × 10⁻⁶ | 6.16 × 10⁻⁶ |
| psi⁻¹ | | | | | | | | |
| IRP compressibility | 1.67 × 10⁻⁷~ | 9.77 × 10⁻⁸~ | 3.48 × 10⁻⁷~ | 7.02 × 10⁻⁹~ | 6.6 × 10⁻⁸~ | 2.92 × 10⁻⁷~ | 2.66 × 10⁻⁸~ | 9.43 × 10⁻⁷~ |
| range, psi⁻¹ | 4.96 × 10⁻⁸ | 3.00 × 10⁻⁸ | 1.02 × 10⁻⁷ | 1.41 × 10⁻⁹ | 1.5 × 10⁻⁸ | 8.88 × 10⁻⁸ | 6.06 × 10⁻⁹ | 2.88 × 10⁻⁷ |
| Intrusion pressure, psi | 13346 | 5950 | 17790 | 6304 | 9987 | 16785 | 4000 | 5950 |
| K₂, coefficient for | 0.00297 | 0.00292 | 0.0043 | 0.00917 | 0.0135 | 0.00398 | 0.0073 | 0.00208 |
| power law | | | | | | | | |
| function of C_{ac} | | | | | | | | |
| m, power for power | −0.6846 | −0.6617 | 0.6887 | −0.9008 | −0.8296 | −0.6675 | −0.8297 | −0.6656 |
| law function | | | | | | | | |

Applications

Pore compressibility has been neglected in most calculations due to a connotation of low significance. The present work demonstrates that accessible pore compressibility values should be considered in calculations instead of measures of total pore compressibility that are conventionally used. The impact of pore volume compressibility calculated from MICP test data will be discussed under two sections: (1) correcting of petrophysical parameters calculated from MICP data such as porosity, capillary pressure curve, saturation curve, pore size distribution, and permeability, and (2) positive and negative contributions of pore compressibility on reservoir performance and deliverability such as impact on permeability reduction and well deliverability.

Correction of Petrophysical Parameters Calculated from MICP Data

Until the present work, the contribution of inaccessible pore compressibility had not been considered although conformance correction and grain compressibility effect had been taken in account on accurate estimation of parameters calculated from MICP data. However, it is valuable to correct for compression of inaccessible pores, since inaccessible pore volume compaction has been observed and reported around the unfilled regions of samples. Therefore, in at least certain embodiments of the presently disclosed method, three distinct corrections can be used to improve the accuracy of estimates of petrophysical parameters calculated from MICP data: (1) conformance, (2) IRP compression. Impact of these corrections are summarized below:

Porosity

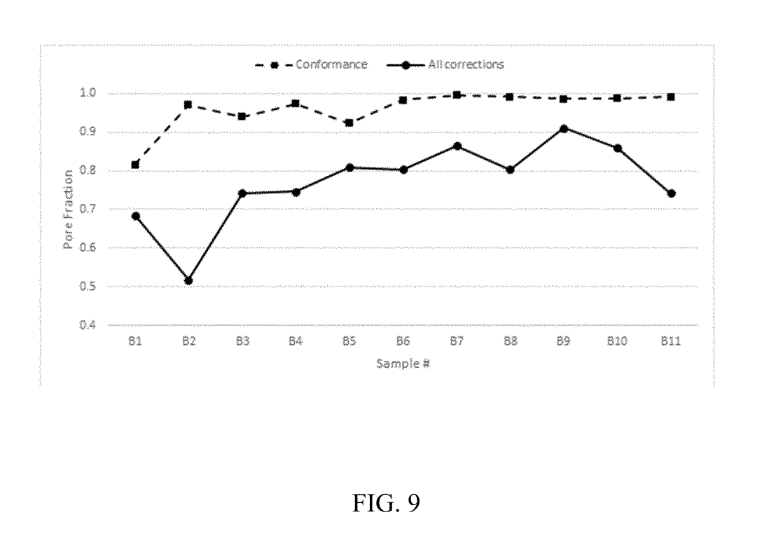

Based on the disclosed model, accessible porosity calculated from MICP data are compared with and without considering corrections for Barnett shale samples. FIG. 9 summarizes and illustrates the contribution corrections on the calculated porosity fraction values (ϕ/ϕ_{Hg}). In general, conformance correction has the least effect while IRP compression correction is the one with highest impact. When the effect of IRP compression is investigated it can be concluded that it can significantly alter results, which is why the compression correction should also be included in the porosity calculations.

Capillary Pressure Curve

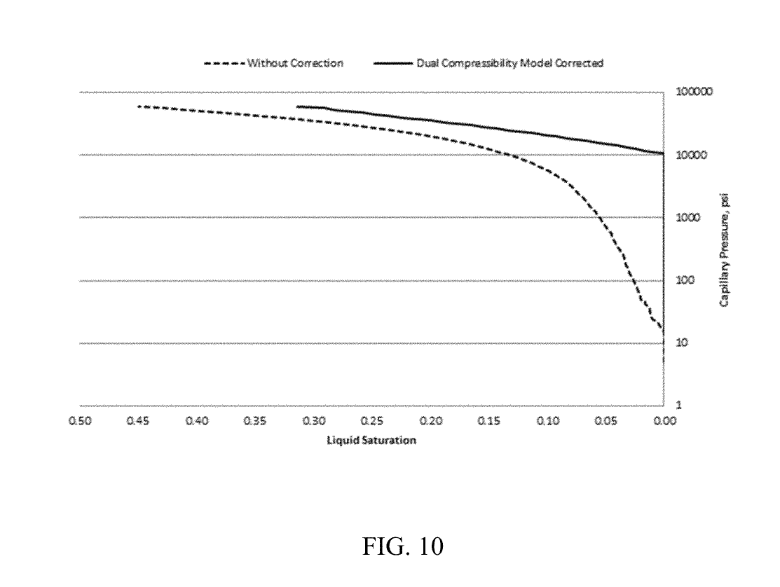

Capillary pressure versus the saturation curve can also be corrected as a result of significant pore shrinkage and lack of intrusion before the critical intrusion pressure. Liquid saturation remains zero before the pressure reaches the conformance pressure, and starts to increase as pressure surpasses said point. Pore volume decreases as a function of effective stress due to the compressibility of accessible pores and IRP. FIG. 10 shows results for the calculated capillary pressure curve with and without any correction. Results indicate that there is a misinterpretation in pore size distribution from the capillary pressure curve in the industry. Correction provides a more accurate capillary pressure curve.

Saturation Curve and Pore Size Distribution

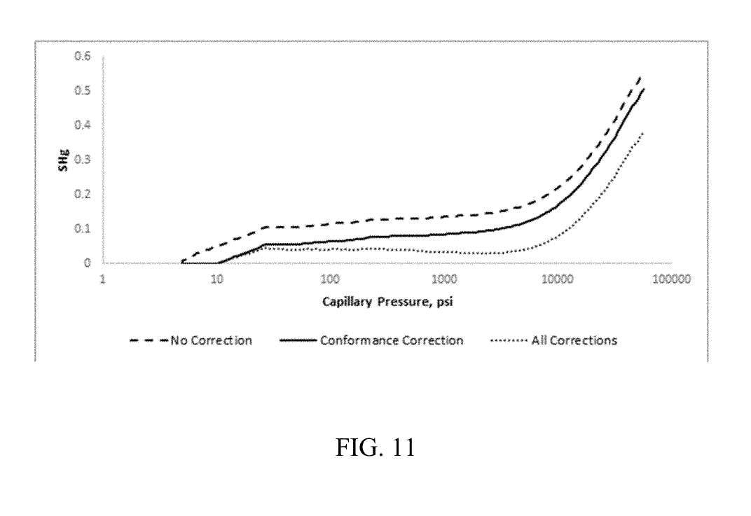

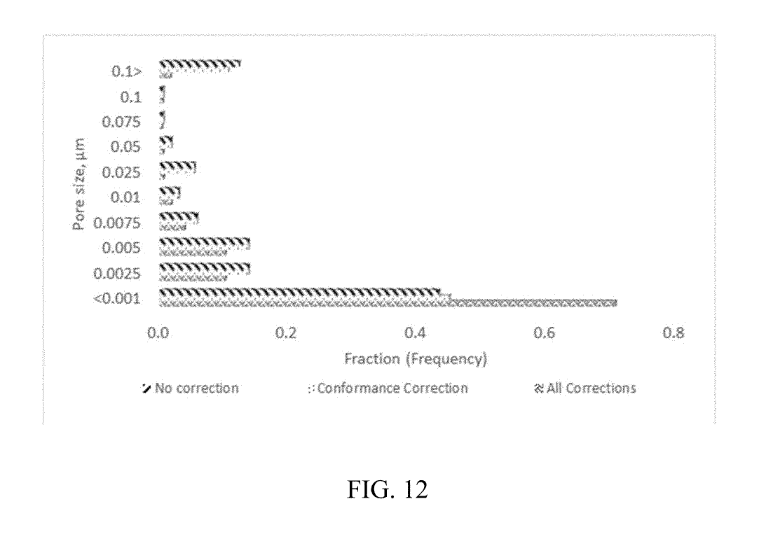

One of the Barnett shale samples was selected to further study the impact of pore compressibility corrections on both mercury saturation curve and pore size distribution. Since suggested corrections reduce a volume of mercury that is actually associated with pore volume filling, it does not come as a surprise that it will have a substantial effect on results. An example of a cumulative saturation curve including effects of corrections is shown in FIG. 11, which indicates that results can significantly change when corrections are considered in the calculations. As a result, this will also have an effect on pore size distribution as shown in FIG. 12, suggesting that pore size shifts toward smaller pores when corrections are considered.

Permeability

Several models have been developed to estimate absolute permeability values based on MICP data. One of the most widespread and accurate of those models is Swanson method, which is expressed as a function of a maximum value among a ratio of bulk volume saturation to capillary pressure, (S_{b}/p_{c})_{A} representing a critical point. For tight formations, Swanson (1981) suggested to estimate permeability as:

$$k = {431 [ \frac{{S}_{b}}{{p}_{c}} ]}_{A}^{2.109} \qquad Eq . 17$$

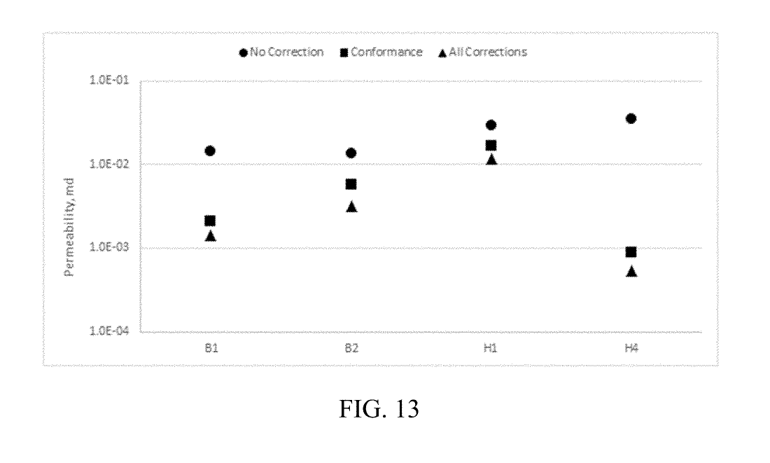

To analyze the effect of the MICP corrections on permeability calculations, two samples from each Barnett and Haynesville formations were selected: (B1, B2, H1 and H4). Results indicate that, when all corrections are considered, permeability can be two orders of magnitude less than the case without any corrections as illustrated in FIG. 13.

Impact on Well Deliverability and Production Performance

Since pore volume compressibility has been considered insignificant, in most calculations it has been neglected. However, based on results shown in FIGS. 5-8, calculated values are more than expected, thus pore volume compressibility will have considerable effect on well deliverability and reservoir performance. As a negative effect it will diminish permeability due to pore volume shrinkage, while on the other hand as a positive effect it will contribute to gas recovery because of a stronger driving mechanism from pore compaction.

Permeability Reduction due to Pore Shrinkage

Katz and Thompson (1986, 1987) introduced the following equation (Eq. 18) to calculate permeability based on the MICP data:

$$k = \frac{1}{89} {L}_{Hmax}^{2} ( \frac{{L}_{Hmax}}{{L}_{c}} ) φ S ( {L}_{Hmax} ) \qquad Eq . 18$$

where k (darcy) is permeability; L_{Hmax} (μm) is the pore throat diameter at which hydraulic conductance is maximum; L_{c} (μm) is the characteristic length which corresponds to the pore diameter at threshold pressure; ϕ is porosity; and S (L_{Hmax}) represents the fraction of connected pore volume including pores with diameter of L_{Hmax} and larger. The threshold pressure P_{c} is determined at the inflection point of the cumulative intrusion curve and the selection of L_{Hmax} is dependent on P_{c}. It can be referred to Webb (2001) and Gao and Hu (2013) for step-by-step procedures to determine parameters needed to calculate permeability based on KT method.

However, neglecting pressure effect on permeability will lead to error, especially in shale formations since the key variables ϕ, L_{c}, and L_{Hmax} change drastically as a function of pressure.

As discussed previously, pore compressibility is expressed as a power law function with respect to confining pressure. Such notation enables us to represent pore volume shrinkage in a similar fashion. As compressibility is defined, one can simply derive Eq. 19:

$$\frac{{V}_{pi}}{{V}_{p}} = {e}^{\frac{{k}_{2}}{m + 1} ( {P}_{c}^{m + 1} - {P}_{{c}_{i}}^{m + 1} )} \qquad Eq . 19$$

where k₂ and m are the coefficients for power law function explaining pore compressibility with changing pressure; and Vₚᵢ stands for original pore volume. We denote the term

$$\frac{{k}_{2}}{m + 1} ( {P}_{c}^{m + 1} - {P}_{{c}_{i}}^{m + 1} )$$

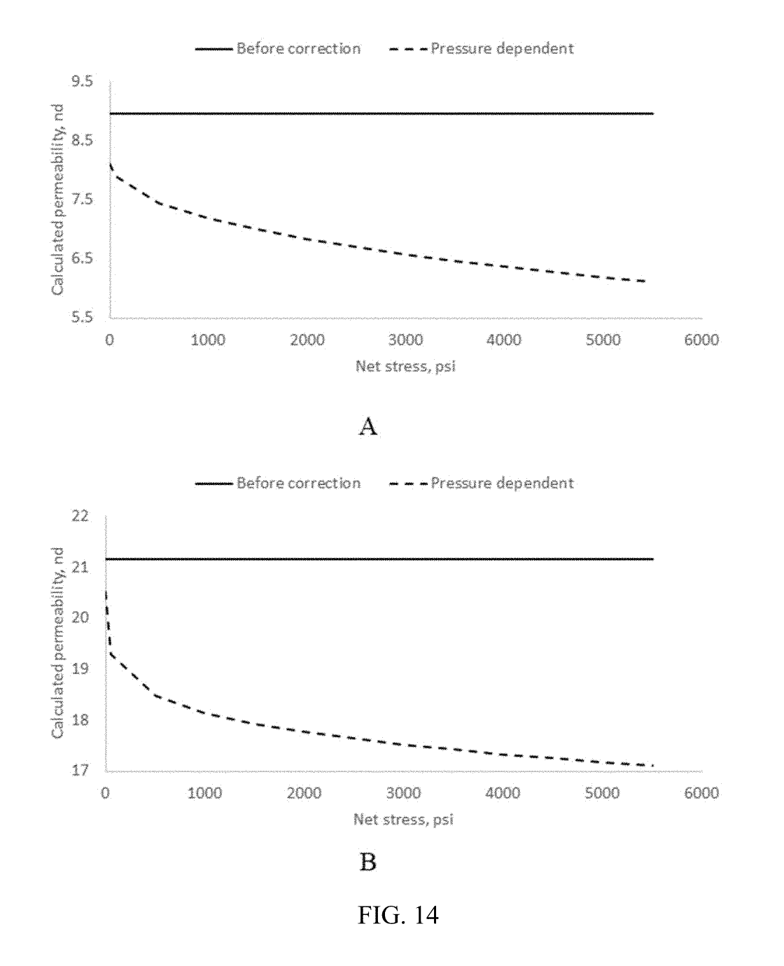

s n, where n is only a function of pressure once the relationship between pore compressibility and pressure has been established from disclosed model. Because of the notation of compressibility, we modified KT equation as such:

$$k = \frac{1}{89} {L}_{Hmax}^{2} ( \frac{{L}_{Hmax}}{{L}_{c}} ) φ S ( {L}_{Hmax} ) * {e}^{- β n} \qquad Eq . 20$$

where β is a shape coefficient, which varies by different assumed pore shapes: β is equal to 2 if pores are considered to be cylindrical shaped, β is equal to 5/3 when pores are considered to be spherical shaped. Compression mechanism varies based on pore geometry and grain structure. Two samples from Haynesville formation are analyzed to evaluate effect of compressibility on permeability reduction. Results for calculated permeability values from Hayneville are illustrated in FIG. 14. Results indicate that for chosen samples, calculated permeability values are around 9 nd and 21 nd. Moreover, compressibility correction has significant impact on calculated results. As it can be seen, after compressibility correction permeability reduces sharply at initial stage of confining pressure increase but the decline rate slows down as confining pressure increases. Generally, permeability decreases by 20% to 30% after compressibility correction under the confining pressure of 6000 psi. This is expected since permeability is a strong function of pore size and porosity and since compressibility is high in shale formations, it shows significant impact.

Impact on Gas Recovery

How the calculated accessible pore compressibility values affect production recovery in several shale gas plays was investigated. The results indicate that replacing the total pore compressibility parameter with the accessible pore compressibility parameter can significantly change the prediction of the behavior of a reservoir. The conventional measure of reservoir compaction has been total pore compressibility, which as noted above generally has a value within the range of 1×10⁻⁶ to 1×10⁻⁵ psi⁻¹. By recognizing the part of the pore system that actually contributes to production, and identifying its compressibility, we can substitute values of total pore compressibility with values of accessible pore compressibility. This changes the compressibility value by nearly two orders of magnitude. In the present work. macroscopic material balance was used to evaluate impact of pore compaction on gas recovery. In case of gas reservoirs, the main production mechanisms are fluid expansion, water expansion, rock expansion, and gas desorption in shale formations. Using the modified macroscopic material balance equation below (Eq. 21) derived by Yuan et. al (2016), the effect of compressibility on gas recovery can be analyzed.

$$\frac{{G}_{p}}{{G}_{fgi}} = [ \frac{{B}_{g} - {B}_{gi}}{{B}_{g}} ] + \frac{1}{( 1 - {S}_{wi} )} ( {c}_{a c} + {S}_{wi} {c}_{w} ) ( {P}_{i} - P ) \frac{{B}_{gi}}{{B}_{g}} + \frac{{B}_{gi}}{( 1 - {S}_{wt} )} {ρ}_{r} {υ}_{max} [ \frac{{bP}_{i}}{1 + {bP}_{i}} - \frac{bP}{1 + bP} ] \qquad Eq . 21$$

Eq. 21 is used to calculate depletion efficiency for a shale gas reservoir, which describes the potential recovery within the drainage area. The right side of the equation gives the individual terms that mathematically define different production mechanisms during recovery; the first term expresses free gas expansion; the second term represents rock and water expansion; and the third term denotes gas desorption. In order to study and analyze each driving index, we made a synthetic reservoir model whose parameters used are shown in Table 2.

The contribution from each driving index is calculated for different compressibility values. We studied two cases; (1) when total pore compressibility is used in calculations and (2) when only the accessible pore compressibility with respect to pore pressure value is considered. Using 3×10⁻⁶ as the total pore compressibility in the rock expansion term, the contribution from rock expansion is less than 1%, while the gas desorption term and gas expansion term each has 4.2% and 95.1% contribution. By increasing the compressibility value from 3×10⁻⁶ to 5×10⁻⁵ psi⁻¹, rock expansion contribution increased dramatically to 10.2%, while gas desorption and gas expansion indices dropped to 3.8% and 85.9%. As a result, depletion efficiency increased by 8.0% within the drainage area.

TABLE 2
Values used in macroscopic material balance equation Eq. 21.

| Variable | Value |
|---|---|
| Pᵢ, psi | 6204 |
| P, psi | 1450 |
| S_{wi}, % | 20 |
| C_{w}, psi⁻¹ | 0 |
| ρ_{rock}, g/ml | 2.68 |
| νₘₐₓ | 6.38 |
| b | 0.1 |
| B_{gi}, rcf/scf | 0.00343824 |
| B_{g}, rcf/scf | 0.01201046 |

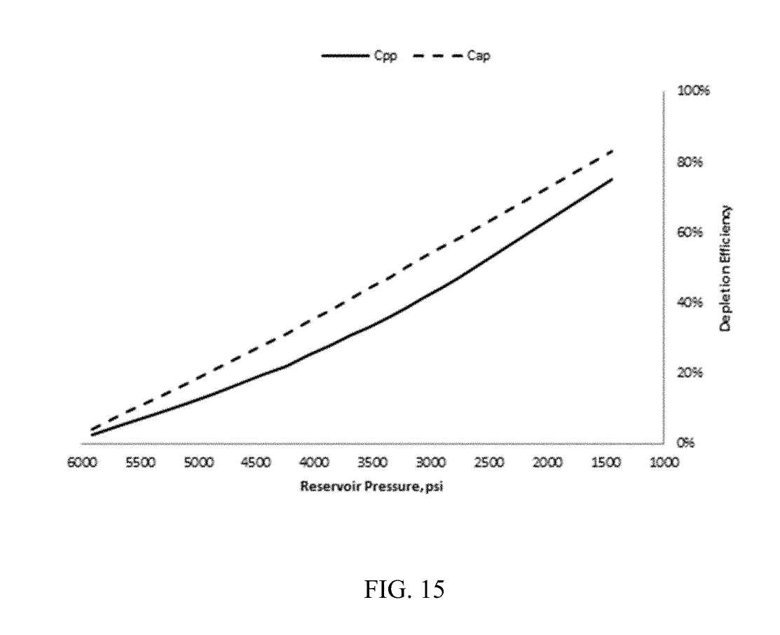

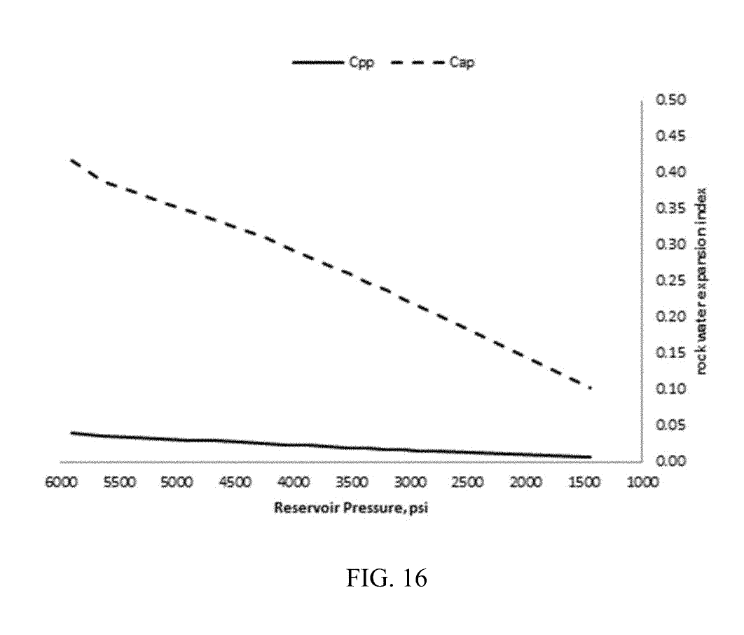

The results are plotted in FIGS. 15 and 16. Both depletion efficiency (FIG. 15) and rock expansion index (FIG. 16), as explained by Moghanloo (2015), show a significant increase after the calculated accessible pore compressibility value is applied into the macroscopic material balance equation.

Efficient Fracturing Design

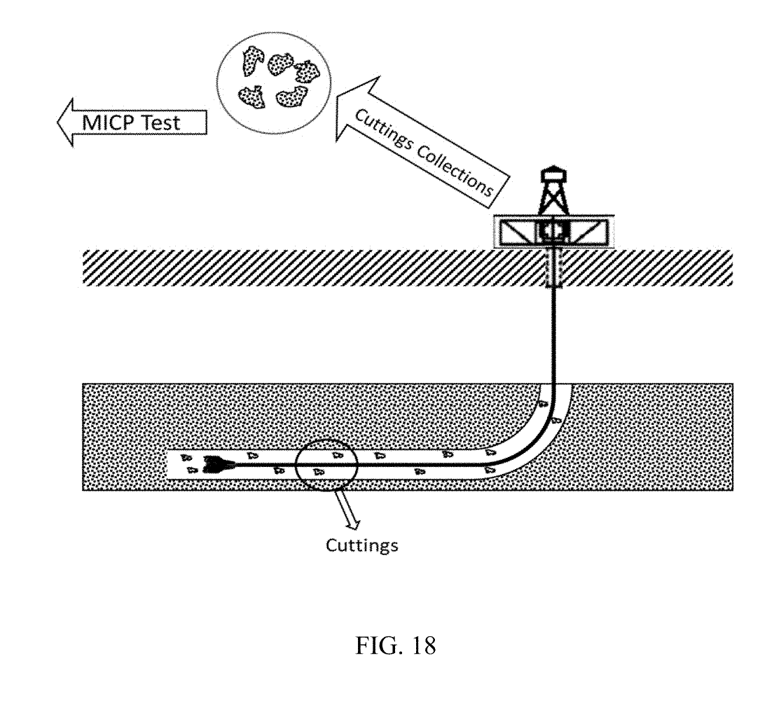

The identification of highly productive regions within the lateral section of a wellbore enable a fracturing design, which improves the efficiency and economic results of a production operation. In order to do that, drilling cuttings obtained periodically corresponding to specific depth can be evaluated in terms of accessible porosity (ϕₐ=aϕ), and accessible pore volume compressibility (FIG. 18). In terms of reservoir quality and production performance, if impact of accessible porosity is considered to be higher than pore volume compressibility, by orders of η, then the overall efficiency of certain region can be normalized as follow:

$$\frac{{{C}_{a {c}_{i}} ( {φ}_{{a}_{i}} )}^{η}}{{\sum }_{i = 1}^{n} {{C}_{a {c}_{i}} ( {φ}_{{a}_{i}} )}^{η}} \qquad Eq . 22$$

where n is a number of samples. The larger the normalized efficiency factor for a region, the better quality of that specific region.

As shown above, accurate formation evaluation in shale reservoirs involves precise estimation of accessible porosity, permeability, driving mechanisms and dynamic well deliverability/permeability. These quantities are important for estimating the reservoir performance quality, and measurement of these quantities as a function of depth is desirable in every well in shale plays.

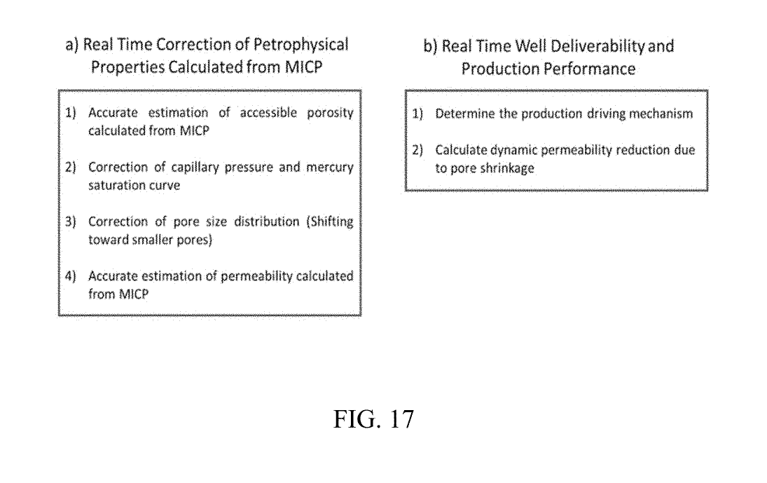

For accurate estimation all these quantities from MICP test data, embodiments disclosed herein present a novel methodology to calculate pore compressibility for shale samples, correct petrophysical parameters estimated from MICP data, and calculate critical reservoir parameters as a function of pressure as shown, for example, in FIG. 17.

Results shown herein indicate that calculated accessible pore compressibility values are greater than expected for shale samples; therefore, its use in reservoir calculations will generally result in more accurate predictions of the amount of hydrocarbon that can be recovered from a particular region or stratum of a formation. This will also have a substantial effect on petrophysical parameters calculated from MICP test data. When the pore compressibility effect is considered in calculations, accessible porosity estimated from MICP data decreases significantly. Furthermore, the results indicate that inclusion of correction shift pore size distribution toward smaller pores and it can dramatically reduce permeability estimations down to two orders of magnitude smaller than the original values.

Finally, when the impact of pore compressibility on reservoir performance is evaluated, the present results indicate that as a positive effect rock compaction will have a greater contribution on production than previously believed, while as a negative effect dynamic/pressure dependent permeability will reduce up to 30% of its initial value.

The overall goal of the methods disclosed herein is to provide timely, lower cost formation property estimates to facilitate more efficient and accurate estimation of reservoir performance and well deliverability. The present disclosure enables the improved exploitation of information, which can be collected from cuttings and/or core samples obtained during a drilling operation (schematically represented in FIG. 18). For example, as explained above, a real-time assessment of an unconventional shale resource can be made using information derived from drilling cuttings. The real-time assessment based on this information can be used to design a much more efficient fracturing and/or perforation treatment (design) for implementation after a drilling operation is concluded. For example, specific stages at certain intervals of the horizontal section of the wellbore can be identified for more or less fracturing and/or perforation treatment, that is, the intensity of fracture density can be altered along the path of the wellbore (borehole), enabling more concentrated exploitation of those areas along the wellbore with high levels of accessible pores, resulting in a more productive well completed at lower cost.

In at least one non-limiting embodiment, the present disclosure is directed to a method for analyzing a subterranean formation (hydrocarbon reservoir), comprising: (1) obtaining a rock sample from a borehole that traverses the subterranean formation; (2) conducting a mercury injection capillary pressure (MICP) test on the rock sample to obtain MCIP data including measures of accessible pore compressibility and inaccessible part of the rock (IRP) compressibility of the rock sample; (3) conducting a crushed sample test on the rock sample to obtain a measure of total porosity of the rock sample; (4) characterizing the MCIP data according to at least one stage of conformance, bulk compression and intrusion, and differentiating the at least one stage of conformance, bulk compression, and intrusion from a log-log plot of cumulative mercury volume change with respect to confining pressure; (5) calculating a measure of bulk volume compressibility from a section of said log-log plot; (6) calculating a measure of accessible pore fraction and a measure of coefficient of accessible pore compressibility; and (7) designing an oil field service by using the measures of coefficient of accessible pore compressibility and accessible pore fraction in a reservoir simulation model, the designed oil field service to be performed in the borehole. The rock sample may be a sample of cuttings. The oil field service may be a hydraulic fracturing service, a perforation service, an acidizing service, and/or a completion service comprising a plan of the number and location of stages to be completed in the borehole. The section of the log-log plot may be a linear function portion of the log-log plot having R²>0.90 (e.g., R²>0.90, R²>0.91, R²>0.92, R²>0.93, R²>0.94, R²>0.95, R²>0.96, R²>0.97, R²>0.98, or R²>0.99). The linear function portion may be determined by fitting the MICP data to a linear function (for example, by using regression analysis to identify the portion of the data having R²>0.90), wherein the section may be substantially linear (as “substantially” is defined elsewhere herein). The method may include correcting an estimate of accessible porosity and fluid saturated porosity by including an effect of conformance, grain and pore compressibility. The method may include correcting at least one petrophysical parameter calculated from the MICP data. The at least one petrophysical parameter calculated from the MICP data may be selected from the group consisting of capillary pressure curve, saturation curve, pore size distribution, and permeability. The method may include correcting the petrophysical parameter calculated from the MICP data by including an effect of conformance, grain and pore compressibility. The measures of accessible pore fraction and coefficient of accessible pore compressibility may be calculated by simultaneous solution of Eq. 7, Eq. 13, and Eq. 15. The method may include modifying an MICP-based intrinsic permeability model by considering the negative effect of pore compressibility with increasing effective stress using Eq. 20.

In at least one non-limiting embodiment, the present disclosure is directed to a method of performing an oil field service on a subterranean formation, the method comprising: (1) obtaining a rock sample from a borehole in the subterranean formation; (2) conducting a mercury injection capillary pressure (MICP) test on the rock sample to obtain MCIP data including measures of accessible pore compressibility and inaccessible part of the rock (IRP) compressibility of the rock sample; (3) conducting a crushed sample test on the rock sample to obtain a measure of total porosity of the rock sample; (4) characterizing the MCIP data according to at least one stage of conformance, bulk compression and intrusion, and differentiating the at least one stage of conformance, bulk compression, and intrusion from a log-log plot of cumulative mercury volume change with respect to confining pressure; (5) calculating a measure of bulk volume compressibility from a section of said log-log plot; (6) calculating a measure of accessible pore fraction and a measure of coefficient of accessible pore compressibility; (7) designing the oil field service by using the measures of coefficient of accessible pore compressibility and accessible pore fraction in a reservoir simulation model; and (8) performing the designed oil field service within the borehole of the subterranean formation. The rock sample may be a sample of cuttings. The oil field service may be a hydraulic fracturing service, a perforation service, an acidizing service, and/or a completion service comprising a plan of the number and location of stages to be completed in the borehole. The section of the log-log plot may be a linear function portion of the log-log plot having R²>0.90 (e.g., R²>0.90, R²>0.91, R²>0.92, R²>0.93, R²>0.94, R²>0.95, R²>0.96, R²>0.97, R²>0.98, or R²>0.99). The linear function portion may be determined by fitting the MICP data to a linear function (for example, by using regression analysis to identify the portion of the data having R²>0.90), wherein the section may be substantially linear (as “substantially” is defined elsewhere herein). The method may include correcting an estimate of accessible porosity and fluid saturated porosity by including an effect of conformance, grain and pore compressibility. The method may include correcting at least one petrophysical parameter calculated from the MICP data. The at least one petrophysical parameter calculated from the MICP data may be selected from the group consisting of capillary pressure curve, saturation curve, pore size distribution, and permeability. The method may include correcting the petrophysical parameter calculated from the MICP data by including an effect of conformance, grain and pore compressibility. The measures of accessible pore fraction and coefficient of accessible pore compressibility may be calculated by simultaneous solution of Eq. 7, Eq. 13, and Eq. 15. The method may include modifying an MICP-based intrinsic permeability model by considering the negative effect of pore compressibility with increasing effective stress using Eq. 20.

In at least one non-limiting embodiment, the present disclosure is directed to a computer-readable storage medium having instructions stored therein for performing an oil field service within a borehole of a subterranean formation, wherein the instructions are determined by (1) obtaining a rock sample from a borehole in the subterranean formation; (2) conducting a mercury injection capillary pressure (MICP) test on the rock sample to obtain MCIP data including measures of accessible pore compressibility and inaccessible part of the rock (IRP) compressibility of the rock sample; (3) conducting a crushed sample test on the rock sample to obtain a measure of total porosity of the rock sample; (4) characterizing the MCIP data according to at least one stage of conformance, bulk compression and intrusion, and differentiating the at least one stage of conformance, bulk compression, and intrusion from a log-log plot of cumulative mercury volume change with respect to confining pressure; (5) calculating a measure of bulk volume compressibility from a section of said log-log plot; (6) calculating a measure of accessible pore fraction and a measure of coefficient of accessible pore compressibility; and (7) designing the oil field service by using the measures of coefficient of accessible pore compressibility and accessible pore fraction in a reservoir simulation model. The rock sample may be a sample of cuttings. The oil field service may be a hydraulic fracturing service, a perforation service, an acidizing service, and/or a completion service comprising a plan of the number and location of stages to be completed in the borehole. The section of the log-log plot may be a linear function portion of the log-log plot having R²>0.90 (e.g., R²>0.90, R²>0.91, R²>0.92, R²>0.93, R²>0.94, R²>0.95, R²>0.96, R²>0.97, R²>0.98, or R²>0.99). The linear function portion may be determined by fitting the MICP data to a linear function (for example, by using regression analysis to identify the portion of the data having R²>0.90), wherein the section may be substantially linear (as “substantially” is defined elsewhere herein). The method may include correcting an estimate of accessible porosity and fluid saturated porosity by including an effect of conformance, grain and pore compressibility. The method may include correcting at least one petrophysical parameter calculated from the MICP data. The at least one petrophysical parameter calculated from the MICP data may be selected from the group consisting of capillary pressure curve, saturation curve, pore size distribution, and permeability. The method may include correcting the petrophysical parameter calculated from the MICP data by including an effect of conformance, grain and pore compressibility. The measures of accessible pore fraction and coefficient of accessible pore compressibility may be calculated by simultaneous solution of Eq. 7, Eq. 13, and Eq. 15. The method may include modifying an MICP-based intrinsic permeability model by considering the negative effect of pore compressibility with increasing effective stress using Eq. 20.

In at least one non-limiting embodiment, the present disclosure is directed to a non-transitory computer-readable storage medium having instructions stored therein, which when executed by a processor, cause the processor to perform functions including the computer-implemented functions of the methods disclosed herein. For example, the computer-implemented method for determining an oil field service for a subterranean formation (hydrocarbon reservoir) may comprise the steps of (1) obtaining a rock sample from a borehole in the subterranean formation (hydrocarbon reservoir); (2) conducting a mercury injection capillary pressure (MICP) test on the rock sample to obtain MICP data including measures of accessible pore compressibility and inaccessible part of the rock (IRP) compressibility of the rock sample; (3) conducting a crushed sample test on the rock sample to obtain a measure of total porosity of the rock sample (e.g., from an LPP test); (4) characterizing the MICP data according to phases (stages) of conformance, bulk compression and intrusion, and differentiating the conformance, bulk compression, and intrusion phases (stages) from a log-log plot of cumulative mercury volume change with respect to confining pressure; (5) calculating a measure of bulk volume compressibility from a section of the above log-log plot, where the section is determined by fitting the MICP data to a linear function (for example, by using regression analysis to identify the portion of the data having R²>0.90, R²>0.91, R²>0.92, R²>0.93, R²>0.94, R²>0.95, R²>0.96, R²>0.97, R²>0.98, or R²>0.99), wherein the section may be substantially linear (as “substantially” is defined elsewhere herein); (6) calculating a measure of accessible pore fraction and a measure of coefficient of accessible pore compressibility; and (7) using the measures of coefficient of accessible pore compressibility and accessible pore fraction in a reservoir simulation model to design an oil field service to be performed within the borehole of the subterranean formation (hydrocarbon reservoir). In various non-limiting embodiments of the method, the rock sample may be a sample of cuttings, the oil field service may be a hydraulic fracturing service, the oil field service may be a perforation service, the oil field service may be an acidizing service, and/or the oil field service may be a well completion plan which includes a number of stages and location of the stages to be completed in the borehole. The method may include performing the oil field service within the borehole of the subterranean formation (hydrocarbon reservoir). The method may include correcting an estimate of accessible porosity and fluid saturated porosity by including an effect of conformance, grain, and pore compressibility. The method may include correcting at least one petrophysical parameter calculated from the MICP data. The at least one petrophysical parameter calculated from the MICP data may be selected from the group consisting of capillary pressure curve, saturation curve, pore size distribution, and permeability. The method may include correcting the petrophysical parameter calculated from the MICP data by including an effect of conformance, grain, and pore compressibility. The measures of accessible pore fraction and coefficient of accessible pore compressibility may be calculated by simultaneous solution of Eq. 7, Eq. 13, and Eq. 15. The method may include modifying an MICP-based intrinsic permeability model by considering the negative effect of pore compressibility with increasing effective stress using Eq. 20.

In at least one non-limiting embodiment, the present disclosure is directed to a system for analyzing a subterranean formation to determine an oil field service for a subterranean formation, the system comprising: at least one processor, and a memory including instructions stored therein, which when executed by the processor, cause the processor to (1) characterize mercury injection capillary pressure (MCIP) data according to at least one stage of conformance, bulk compression and intrusion, and differentiating the at least one stage of conformance, bulk compression, and intrusion from a log-log plot of cumulative mercury volume change with respect to confining pressure; (2) calculate a measure of bulk volume compressibility from a section of said log-log plot; (3) calculate a measure of accessible pore fraction and a measure of coefficient of accessible pore compressibility; and (4) design the oil field service by using the measures of coefficient of accessible pore compressibility and accessible pore fraction in a reservoir simulation model. The system may rely on data collected from a rock sample obtained from a borehole of the subterranean formation, wherein the rock sample may comprise a sample of cuttings. The oil field service may be a hydraulic fracturing service, a perforation service, an acidizing service, and/or a completion service comprising a plan of the number and location of stages to be completed in the borehole. The section of the log-log plot may be a linear function portion of the log-log plot having R²>0.90 (e.g., R²>0.90, R²>0.91, R²>0.92, R²>0.93, R²>0.94, R²>0.95, R²>0.96, R²>0.97, R²>0.98, or R²>0.99). The linear function portion may be determined by fitting the MICP data to a linear function (for example, by using regression analysis to identify the portion of the data having R²>0.90), wherein the section may be substantially linear (as “substantially” is defined elsewhere herein). The method may include correcting an estimate of accessible porosity and fluid saturated porosity by including an effect of conformance, grain and pore compressibility. At least one petrophysical parameter calculated from the MICP data may be corrected. The at least one petrophysical parameter calculated from the MICP data may be selected from the group consisting of capillary pressure curve, saturation curve, pore size distribution, and permeability. The petrophysical parameter calculated from the MICP data may be corrected by including an effect of conformance, grain and pore compressibility. The measures of accessible pore fraction and coefficient of accessible pore compressibility may be calculated by simultaneous solution of Eq. 7, Eq. 13, and Eq. 15. An MICP-based intrinsic permeability model may be modified by considering the negative effect of pore compressibility with increasing effective stress using Eq. 20.

While the present disclosure has been described in connection with certain embodiments so that aspects thereof may be more fully understood and appreciated, it is not intended that the present disclosure be limited to these particular embodiments. On the contrary, it is intended that all alternatives, modifications and equivalents are included within the scope of the present disclosure. Thus the examples described above, which include particular embodiments, will serve to illustrate the practice of the present disclosure, it being understood that the particulars shown are by way of example and for purposes of illustrative discussion of particular embodiments only and are presented in the cause of providing what is believed to be the most useful and readily understood description of procedures as well as of the principles and conceptual aspects of the presently disclosed methods. Changes may be made in various aspects of the methods described herein without departing from the spirit and scope of the present disclosure. The various elements, components, and/or steps of the present disclosure may be combined or integrated in another system or certain features may be omitted, or not implemented. In addition, techniques, systems, subsystems, and methods described and illustrated in the various embodiments as discrete or separate may be combined or integrated with other systems, components, techniques, or methods without departing from the scope of the present disclosure. Other items shown or discussed as coupled may be directly coupled or communicating with each other or may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

### REFERENCES

The following documents are expressly incorporated herein by reference in their entireties.

Andersen, A. and Jones, F. 1985. A comparison of hydrostatic-stress and uniaxial-strain pore-volume compressibilities using nonlinear elastic theory. 26th US Symposium on Rock Mechanics. Rapid City, S.D. 26-28 June.

Andersen, M. A. 1988. Predicting Reservoir-Condition PV Compressibility from Hydrostatics Stress Laboratory Data. SPE Reservoir Engineering, V 3, p 1-78. SPE 14213.

Bailey, S. 2009. Closure and Compressibility Corrections to Capillary Pressure Data in Shales. DWLS Workshop presented 19 October 2009, Golden, Colo.

Biot, M. A. 1941. General Theory of Three-Dimensional Consolidation. Journal of applied physics, V 12, p 155-164.

Civan, F. (2003, January). Leaky-tube permeability model for identification, characterization, and calibration of reservoir flow units. In SPE Annual Technical Conference and Exhibition. Society of Petroleum Engineers.

Comisky, J. T. Santiago, M., McCollom, B., Buddhala, A., & Newsham, K. E. 2011. Sample Size Effects on the Application of Mercury Injection Capillary Pressure for Determining the Storage Capacity of Tight Gas and Oil Shales. Society of Petroleum Engineers. doi:10.2118/149432-MS

Curtis, M. E. Ambrose, R. J., and Sondergeld, C. H. 2011. Investigating the Microstructure of Gas Shales by FIB/SEM Tomography & STEM Imaging

Dastidar, R. 2007. Nuclear Magnetic Resonance (NMR) Study Of Freezing and Thawing Of Saturated Porous Media And Application To Shale and Pore Volume Compressibility Estimation. Dissertation, University of Oklahoma, Norman, Okla.

Davudov, D. Ghanbarnezhad Moghanloo, R., Yuan, B., 2016. Impact of Pore Connectivity and Topology on Gas Productivity in Barnett and Haynesville Shale Plays. Unconventional Resources Technology Conference (URTeC) San Antonio, Tex., USA, 1-3 Aug. 2016. DOI 10.15530-urtec-2016-2461331

Davudov, D., Ghanbarnezhad Moghanloo, R., Lan, Y., Vice, D. 2017. Investigation of Shale Pore Compressibility Impact on Production with Reservoir Simulation. SPE Unconventional Resources Conference. 15-16 Feb. 2017. DOI 10.2118/185059-MS

Dobrynin, V. M. (1962, Dec. 1). Effect of Overburden Pressure on Some Properties of Sandstones. Society of Petroleum Engineers. doi:10.2118/461-PA

Ewing, R. P. Horton, R. 2002. Diffusion in sparsely connected pore spaces: temporal and spatial scaling. Water Resources Research 38 (12), 1285. doi:10.1029/2002WR001412.

Gao, Z. and Hu Q. 2012. Estimating Permeability Using Median Pore-throat Radius Obtained from Mercury Intrusion Porosimetry. J. Geophys. Eng. 10 025014.

Geertsma, J. 1966. Problems of Rock Mechanics in Petroleum Production Engineering. Presented at the 1st ISRM Congress, Lisbon, Portugal, 25 September 1 October. Hu, Q., Ewing, R. P., Dultz, S. 2012. Low pore connectivity in natural rock. J. Contaminant Hydrol. 133, 76-83.

Katz, A. J. and Thompson, A. H.: “Quantitative Prediction of Permeability in Porous Rock,” Physical Review B, Vol. 34, No. 11, (December, 1986) 8179-8181

Katz, A. J. and Thompson, A. H.: “Prediction of Rock Electrical Conductivity from Mercury Injection Measurements,” Journal of Geophysical Research, Vol. 92, No. B1 (January 1987), 599-607.

Lan, Y., Ghanbarnezhad Moghanloo, R., & Davudov, D. 22(06) Aug. 1, 2017. Pore Compressibility of Shale Formations. Society of Petroleum Engineers. Doi:10.2118/185059-PA

Lan Y., Davudov D., Moghanloo R. G. Interplay between permeability and compressibility in shale samples. Journal of Petroleum Science and Engineering. Volume 159, 2017, Pages 644-653 3 Oct. 2017.

Laurent, J., Bouteca, M. J., Sarda, J.-P., & Bary, D. (1993, Jun. 1). Pore-Pressure Influence in the Poroelastic Behavior of Rocks: Experimental Studies and Results. Society of Petroleum Engineers. doi:10.2118/20922-PA

Moghanloo R. G., Yuan B., Ingrahama N., Krampf E., Arrowooda J., Dadmohammadi Y., 2015. Applying macroscopic material balance to evaluate interplay between dynamic drainage volume and well performance in tight formations, Journal of Natural Gas Science and Engineering, Volume 27, Part 2, November 2015, Pages 466-478, ISSN 1875-5100.

Niandou, H., Shoa, J., Henry, J., Fourmaintraux, D. 1997. Laboratory investigation of the mechanical behaviour of Tournemire shale. International Journal of Rock Mechanics and Mining Sciences, Volume 34, Issue 1.

Shafer, J., and Neasham, J. 2000. Mercury Porosimetery Protocol for Rapid Determination of Petrophysical and Reservoir Quality Properties. Paper SCA2000-21, Proc. International Symposium of Society of Core Analysts.

Swanson, B. F. (1981). A simple correlation between permeabilities and mercury capillary pressures. Journal of Petroleum Technology, 33(12) 2,498-2,504.

Washburn, E. W., 1921, Note on a method of determining the distribution of pore sizes in a porous material, Proc. Nat. Acad. Sci. of the USA, 7, 115-116.

Webb, P. A. 2001. An introduction to the physical characterization of materials by mercury intrusion porosimetry with emphasis on reduction and presentation of experimental data. Micromeritics Instrument Corporation

Yuan, B., Moghanloo, R. G., and Shariff E. 2016. Integrated Investigation of Dynamic Drainage Volume (DDV) and Inflow Performance Relationship (Transient IPR) to Optimize Multi-stage Fractured Horizontal Wells in Shale Oil. Journal of Energy Resource Technology. 138(5):052901-052901-9. doi :10.1115/1.4032237.

Zimmerman, R., Somerton, W., King, M. 1986. Compressibility of Porous Rocks. Journal of Geophysical Research: Solid Earth, Volume 91, Issue 12.

Zimmerman, R. 2000. Implications of Static Poroelasticity for Reservoir Compaction. American Rock Mechanics Association. 4^{th} North American Rock Mechanics Symposium. July 3, Seattle, Wash.

What is claimed is:

1. A method for analyzing a subterranean formation, comprising:
obtaining a rock sample from a borehole that traverses the subterranean formation;
conducting a mercury injection capillary pressure (MICP) test on the rock sample to obtain MCIP data including measures of accessible pore compressibility and inaccessible part of the rock (IRP) compressibility of the rock sample;
conducting a crushed sample test on the rock sample to obtain a measure of total porosity of the rock sample;
characterizing the MCIP data according to at least one stage of conformance, bulk compression and intrusion, and differentiating the at least one stage of conformance, bulk compression, and intrusion from a log-log plot of cumulative mercury volume change with respect to confining pressure;
calculating a measure of bulk volume compressibility from a section of said log-log plot;
calculating a measure of accessible pore fraction and a measure of coefficient of accessible pore compressibility; and
designing an oil field service by using the measures of coefficient of accessible pore compressibility and accessible pore fraction in a reservoir simulation model, the designed oil field service to be performed in the borehole.

2. The method of claim 1, wherein the rock sample is a sample of cuttings.

3. The method of claim 1, wherein the oil field service is selected from a hydraulic fracturing service, a perforation service, an acidizing service, and a completion service comprising a well completion plan, the well completion plan comprising a number of stages and location of the stages to be completed in the borehole.

4. The method of claim 1, wherein the section of the log-log plot is a linear function portion of the log-log plot having R²>0.90.

5. The method of claim 1, further comprising correcting an estimate of accessible porosity and fluid saturated porosity by including an effect of conformance, grain and pore compressibility.

6. The method of claim 1, further comprising correcting at least one petrophysical parameter calculated from the MICP data.

7. The method of claim 6, wherein the at least one petrophysical parameter calculated from the MICP data is selected from the group consisting of capillary pressure curve, saturation curve, pore size distribution, and permeability.

8. The method of claim 6, further comprising correcting the petrophysical parameter calculated from the MICP data by including an effect of conformance, grain and pore compressibility.

9. The method of claim 1, wherein the measures of accessible pore fraction and coefficient of accessible pore compressibility are calculated by simultaneous solution of the equations:
$${k}_{1} = {ak}_{2} + ( 1 - a φ ) {k}_{3} ;$$
$${V}_{Hg} ( {P}_{ci} ) = {V}_{bsc} - \frac{a φ {V}_{bsc}}{{e}^{[ \frac{{k}_{2}}{m + 1} ( {P}_{ci}^{m + 1} - {P}_{conf}^{m + 1} ) ]}} - \frac{( 1 - a φ ) {V}_{bsc}}{{e}^{[ \frac{{k}_{3}}{m + 1} ( {P}_{ci}^{m + 1} - {P}_{conf}^{m + 1} ) ]}} + {V}_{cf} ; and$$
$${V}_{Hg} ( {P}_{f} ) = {V}_{bsc} - \frac{( 1 - a φ ) {V}_{bsc}}{{e}^{[ \frac{{k}_{3}}{m + 1} ( {P}_{f}^{m + 1} - {P}_{conf}^{m + 1} ) ]}} + {V}_{cf} .$$

10. The method of claim 1, further comprising modifying a MICP-based intrinsic permeability model by considering a negative effect of pore compressibility with increasing effective stress using the equation:
$$k = \frac{1}{89} {L}_{Hmax}^{2} ( \frac{{L}_{Hmax}}{{L}_{c}} ) φ S ( {L}_{Hmax} ) * {e}^{- β n} .$$

11. A method of performing an oil field service on a subterranean formation, the method comprising:
obtaining a rock sample from a borehole in the subterranean formation;
conducting a mercury injection capillary pressure (MICP) test on the rock sample to obtain MCIP data including measures of accessible pore compressibility and inaccessible part of the rock (IRP) compressibility of the rock sample;
conducting a crushed sample test on the rock sample to obtain a measure of total porosity of the rock sample;
characterizing the MCIP data according to at least one stage of conformance, bulk compression and intrusion, and differentiating the at least one stage of conformance, bulk compression, and intrusion from a log-log plot of cumulative mercury volume change with respect to confining pressure;
calculating a measure of bulk volume compressibility from a section of said log-log plot;
calculating a measure of accessible pore fraction and a measure of coefficient of accessible pore compressibility;
designing the oil field service by using the measures of coefficient of accessible pore compressibility and accessible pore fraction in a reservoir simulation model; and
performing the designed oil field service within the borehole of the subterranean formation.

12. The method of claim 11, wherein the rock sample is a sample of cuttings.

13. The method of claim 11, wherein the oil field service is selected from a hydraulic fracturing service, a perforation service, an acidizing service, and a completion service comprising a well completion plan, the well completion plan comprising a number of stages and location of the stages to be completed in the borehole.

14. The method of claim 11, wherein the section of the log-log plot is a linear function portion of the log-log plot having R²>0.95.

15. The method of claim 11, further comprising correcting an estimate of accessible porosity and fluid saturated porosity by including an effect of conformance, grain and pore compressibility.

16. The method of claim 11, further comprising correcting at least one petrophysical parameter calculated from the MICP data.

17. The method of claim 16, wherein the at least one petrophysical parameter calculated from the MICP data is selected from the group consisting of capillary pressure curve, saturation curve, pore size distribution, and permeability.

18. The method of claim 16, further comprising correcting the petrophysical parameter calculated from the MICP data by including an effect of conformance, grain and pore compressibility.

19. The method of claim 11, wherein the measures of accessible pore fraction and coefficient of accessible pore compressibility are calculated by simultaneous solution of the equations:
$${k}_{1} = {ak}_{2} + ( 1 - a φ ) {k}_{3} , \\ {V}_{Hg} ( {P}_{ci} ) = {V}_{bsc} - \frac{a φ {V}_{bsc}}{{e}^{[ \frac{{k}_{2}}{m + 1} ( {P}_{ci}^{m + 1} - {P}_{conf}^{m + 1} ) ]}} - \frac{( 1 - a φ ) {V}_{bsc}}{{e}^{[ \frac{{k}_{3}}{m + 1} ( {P}_{ci}^{m + 1} - {P}_{conf}^{m + 1} ) ]}} + {V}_{cf} , and$$
$${V}_{Hg} ( {P}_{f} ) = {V}_{bsc} - \frac{( 1 - a φ ) {V}_{bsc}}{{e}^{[ \frac{{k}_{3}}{m + 1} ( {P}_{f}^{m + 1} - {P}_{conf}^{m + 1} ) ]}} + {V}_{cf} .$$

20. The method of claim 11, further comprising modifying a MICP-based intrinsic permeability model by considering a negative effect of pore compressibility with increasing effective stress using the equation:
$$k = \frac{1}{89} {L}_{Hmax}^{2} ( \frac{{L}_{Hmax}}{{L}_{c}} ) φ S ( {L}_{Hmax} ) * {e}^{- β n} .$$

21. A computer-readable storage medium, comprising instructions stored therein for performing an oil field service within a borehole of a subterranean formation, wherein the instructions are determined by (1) obtaining a rock sample from a borehole in the subterranean formation; (2) conducting a mercury injection capillary pressure (MICP) test on the rock sample to obtain MCIP data including measures of accessible pore compressibility and inaccessible part of the rock (IRP) compressibility of the rock sample; (3) conducting a crushed sample test on the rock sample to obtain a measure of total porosity of the rock sample; (4) characterizing the MCIP data according to at least one stage of conformance, bulk compression and intrusion, and differentiating the at least one stage of conformance, bulk compression, and intrusion from a log-log plot of cumulative mercury volume change with respect to confining pressure; (5) calculating a measure of bulk volume compressibility from a section of said log-log plot; (6) calculating a measure of accessible pore fraction and a measure of coefficient of accessible pore compressibility; and (7) designing the oil field service by using the measures of coefficient of accessible pore compressibility and accessible pore fraction in a reservoir simulation model.
